(19) United States
(12) Patent Application Publication
(10) Pub. No.: US 2026/0091583 A1
(43) Pub. Date: Apr. 2, 2026

(54) Liquid Ejecting Apparatus And Method Of Controlling Liquid Ejecting Apparatus

(71) Applicant: SEIKO EPSON CORPORATION, Tokyo (JP)

(72) Inventors: Rika TANIMOTO, Matsumoto (JP); Dai NOZAWA, Matsumoto (JP); Noritaka IDE, Shiojiri (JP); Kunio TABATA, Shiojiri (JP); Satoru UEMATSU, Shiojiri (JP)

(21) Appl. No.: 19/343,132

(22) Filed: Sep. 29, 2025

(30) Foreign Application Priority Data
Sep. 30, 2024 (JP) 2024-170147

(51) Int. Cl. B41J 2/045

(52) U.S. Cl. CPC B41J 2/04588; B41J 2/0452; B41J 2/04541; B41J 2/0455; B41J 2/0457; B41J 2/04573; B41J 2/04581; B41J 2/0459

(57) ABSTRACT

In a liquid ejecting apparatus, a drive circuit that outputs a drive signal includes a modulation circuit that outputs a modulated signal, an amplifier circuit that outputs a first amplified modulated signal obtained by amplifying the modulated signal, a level switching signal output circuit that outputs a level switching signal, a level shift circuit that switches, whether to output, as a second amplified modulated signal, a signal obtained by shifting a reference electrical potential of the first amplified modulated signal or output the first amplified modulated signal as the second amplified modulated signal, and a demodulation circuit that outputs the drive signal obtained by demodulating the second amplified modulated signal. The level switching signal output circuit switches an electrical potential of the level switching signal in accordance with at least one of a waveform information signal or a drive element number information signal.

The present application is based on, and claims priority from JP Application Serial Number 2024-170147, filed Sep. 30, 2024, the disclosure of which is hereby incorporated by reference herein in its entirety.

### BACKGROUND

### 1. Technical Field

The present disclosure relates to a liquid ejecting apparatus and a method of controlling a liquid ejecting apparatus.

### 2. Related Art

As a liquid ejecting apparatus that forms an image or a document on a medium by ejecting liquid, an apparatus that uses a piezoelectric element is known. In such a liquid ejecting apparatus, piezoelectric elements are provided corresponding to respective nozzles from which liquid is ejected, and each of the piezoelectric elements is driven based on a drive signal. When the piezoelectric elements are driven, liquid is ejected from the nozzles provided corresponding to the piezoelectric elements. In order to operate the piezoelectric elements, it is necessary to supply a sufficient current. Therefore, a drive circuit that outputs a drive signal for driving the piezoelectric elements includes an amplifier circuit that amplifies a source signal on which the drive signal is based.

JP-A-2010-124040 discloses a circuit that performs pulse modulation on a base drive signal on which a drive signal is based, and that amplifies the pulse-modulated signal and outputs the amplified signal as the drive signal.

However, from the viewpoint of improving the accuracy of a waveform of the output drive signal, the technique described in JP-A-2010-124040 alone is not sufficient, and there is room for improvement.

### SUMMARY

According to an aspect of the present disclosure, there is provided a liquid ejecting apparatus including: an ejection head that includes a plurality of capacitive loads that are driven when a drive signal is supplied to the plurality of capacitive loads, and that ejects liquid by driving the plurality of capacitive loads; a capacitive load drive circuit that outputs the drive signal; and a control circuit that controls the ejection head and the capacitive load drive circuit, wherein the capacitive load drive circuit includes a modulation circuit that outputs a modulated signal obtained by modulating a base drive signal on which the drive signal is based, an amplifier circuit that outputs a first amplified modulated signal obtained by amplifying the modulated signal, a level switching signal output circuit that outputs a level switching signal that changes between a first electrical potential and a second electrical potential, a level shift circuit that outputs, as a second amplified modulated signal, a signal obtained by shifting a reference electrical potential of the first amplified modulated signal when the level switching signal is at the first electrical potential, and that outputs the first amplified modulated signal as the second amplified modulated signal when the level switching signal is at the second electrical potential, and a demodulation circuit that demodulates the second amplified modulated signal and outputs the drive signal, the control circuit outputs a waveform information signal including waveform information of the drive signal, and a drive element number information signal including information indicating the number of elements that are among the plurality of capacitive loads and are to be driven by the drive signal, and the level switching signal output circuit switches an electrical potential of the level switching signal in accordance with at least one of the waveform information signal or the drive element number information signal.

According to an aspect of the present disclosure, there is provided a method of controlling a liquid ejecting apparatus including an ejection head that includes a plurality of capacitive loads that are driven when a drive signal is supplied to the plurality of capacitive loads, and that ejects liquid by driving the plurality of capacitive loads, a capacitive load drive circuit that outputs the drive signal, and a control circuit that controls the ejection head and the capacitive load drive circuit, the method including: outputting a waveform information signal including waveform information of the drive signal, and a drive element number information signal including information indicating the number of elements that are among the plurality of capacitive loads and are to be driven by the drive signal; outputting a modulated signal obtained by modulating a base drive signal on which the drive signal is based; outputting a first amplified modulated signal obtained by amplifying the modulated signal; outputting a level switching signal that changes between a first electrical potential and a second electrical potential; outputting, as a second amplified modulated signal, a signal obtained by shifting a reference electrical potential of the first amplified modulated signal when the level switching signal is at the first electrical potential, and outputting the first amplified modulated signal as the second amplified modulated signal when the level switching signal is at the second electrical potential; and demodulating the second amplified modulated signal and outputting the drive signal, wherein in the outputting the level switching signal, an electrical potential of the level switching signal is switched in accordance with at least one of the waveform information signal or the drive element number information signal.

### BRIEF DESCRIPTION OF THE DRAWINGS

FIG. 1 is a diagram illustrating an example of a structure of a liquid ejecting apparatus.

FIG. 2 is a diagram illustrating a functional configuration of the liquid ejecting apparatus.

FIG. 3 is a diagram illustrating an example of arrangement of a plurality of ejection sections in a head unit.

FIG. 4 is a diagram illustrating an example of a configuration of an ejection section.

FIG. 5 is a diagram illustrating an example of a signal waveform of a drive signal.

FIG. 6 is a diagram illustrating an example of a configuration of a drive signal selection circuit.

FIG. 7 is a diagram illustrating an example of the content of decoding by decoders.

FIG. 8 is a diagram illustrating an example of a configuration of each of selection circuits.

FIG. 9 is a diagram for explaining an operation of the drive signal selection circuit.

FIG. 10 is a diagram illustrating an example of a functional configuration of a drive circuit.

FIG. 11 is a diagram for explaining an operation of the drive circuit.

FIG. 12 is a diagram illustrating an example of a configuration of a level switching signal output circuit.

FIG. 13 is a diagram illustrating an example of a configuration of a high-pass filter included in a feedback circuit.

FIG. 14 is a diagram for explaining an operation of the level switching signal output circuit.

FIG. 15 is a diagram for explaining a mechanism by which overshoot occurs.

FIG. 16 is a diagram for explaining a mechanism by which undershoot occurs.

FIG. 17 is a diagram illustrating a method of controlling the liquid ejecting apparatus and the drive circuit.

FIG. 18 is a diagram illustrating an example of processing of calculating the number of piezoelectric elements to be driven.

### DESCRIPTION OF EMBODIMENTS

Hereinafter, appropriate embodiments of the present disclosure will be described with reference to the drawings. The drawings to be used are for convenience of description. The embodiments described below do not unduly limit the contents described in the appended claims. In addition, not all of configurations to be described below are necessarily essential components of the present disclosure.

In the following description, a consumer ink jet printer of a serial printing type is used as an example of a liquid ejecting apparatus according to the present disclosure. However, the liquid ejecting apparatus is not limited to the serial printing type, and may be of a line printing type. The liquid ejecting apparatus is not limited to a consumer ink jet printer, and may be a business ink jet printer for an office or may be a portable ink jet printer that is driven by a battery or the like and is portable. The liquid ejecting apparatus is not limited to an ink jet printer, and may be, for example, a color material ejecting apparatus that is used for producing a color filter for a liquid crystal display or the like, an electrode material ejecting apparatus that is used for forming an electrode for an organic EL display, a surface emitting display, or the like, a biological organic material ejecting apparatus that is used for producing a biochip, or the like.

### 1. Overview of Liquid Ejecting Apparatus

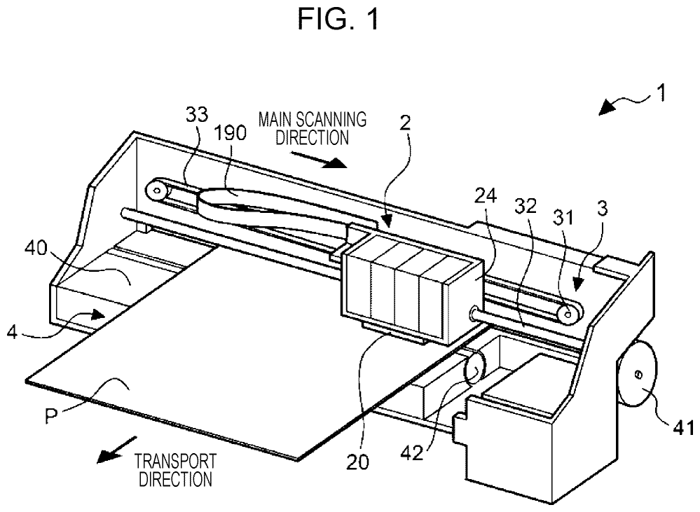

FIG. 1 is a diagram illustrating an example of a structure of a liquid ejecting apparatus 1. As illustrated in FIG. 1, the liquid ejecting apparatus 1 includes a moving body 2 and a moving unit 3 that causes the moving body 2 to reciprocate along a main scanning direction.

The moving unit 3 includes a carriage motor 31 that is a driving source of the reciprocating movement of the moving body 2 along the main scanning direction, a carriage guide shaft 32 of which both ends are fixed, and a timing belt 33 that extends substantially parallel to the carriage guide shaft 32 and is driven by the carriage motor 31.

The moving body 2 includes a carriage 24. The carriage 24 is supported by the carriage guide shaft 32 so as to freely reciprocate, and is fixed to a portion of the timing belt 33. When the timing belt 33 travels forward and backward by the carriage motor 31, the moving body 2 including the carriage 24 reciprocates while being guided by the carriage guide shaft 32. A head unit 20 is located in a portion that is included in the moving object 2 and faces a medium P. That is, the head unit 20 is mounted on the carriage 24. In a surface of the head unit 20 facing the medium P, a large number of nozzles for ejecting ink as an example of liquid are located. Various control signals for controlling an operation of the head unit 20 are supplied to the head unit 20 via a cable 190. As the cable 190, it is possible to use a flexible flat cable or the like that is capable of sliding following the reciprocating movement of the moving body 2.

The liquid ejecting apparatus 1 includes a transport unit 4 that transports the medium P on a platen 40 along a transport direction. The transport unit 4 includes a transport motor 41 that is a driving source for transporting the medium P, and a transport roller 42 that transports the medium P along the transport direction by rotating with a driving force of the transport motor 41.

In the liquid ejecting apparatus 1 configured as described above, the head unit 20 ejects ink onto the medium P in synchronization with a timing at which the medium P is transported by the transport unit 4. Accordingly, the ink ejected by the head unit 20 lands on a desired position on the medium P, and a desired image or character is formed on a front surface of the medium P.

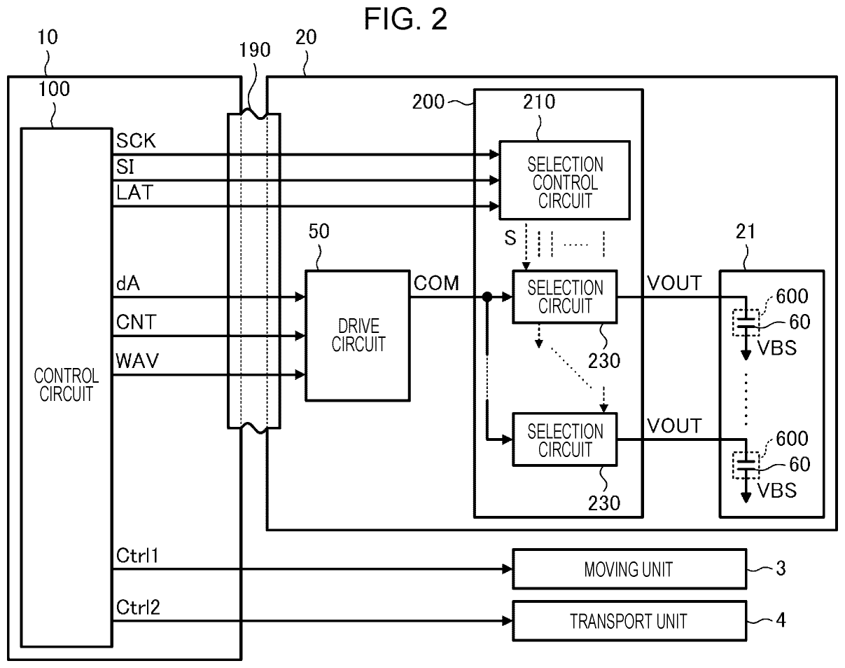

Next, a functional configuration of the liquid ejecting apparatus 1 will be described. FIG. 2 is a diagram illustrating the functional configuration of the liquid ejecting apparatus 1. As illustrated in FIG. 2, the liquid ejecting apparatus 1 includes a control unit 10, the head unit 20, the moving unit 3, the transport unit 4, and the cable 190. The cable 190 electrically couples the control unit 10 and the head unit 20.

The control unit 10 includes a control circuit 100.

Image data is supplied to the control circuit 100 from an external apparatus (not illustrated) provided outside the liquid ejecting apparatus 1, for example. The external apparatus is a host computer or the like. The control circuit 100 generates various control signals for controlling each section of the liquid ejecting apparatus 1 by performing various types of image processing or the like on the supplied image data and outputs the control signals to each section of the liquid ejecting apparatus 1. The control circuit 100 includes, for example, a processor such as a CPU.

Specifically, the control circuit 100 generates, based on the image data, a control signal Ctrl1 for controlling the reciprocating movement of the moving body 2, and outputs the control signal Ctrl1 to the carriage motor 31 included in the moving unit 3. The control circuit 100 generates, based on the image data, a control signal Ctrl2 for controlling the transport of the medium P, and outputs the control signal Ctrl2 to the transport motor 41 included in the transport unit 4. Accordingly, the reciprocating movement of the moving object 2 along the main scanning direction and the transport of the medium P along the transport direction are controlled by the control circuit 100. That is, the head unit 20 can eject the ink onto the medium P at a predetermined timing synchronized with the transport of the medium P. As a result, the ink can land on the desired position on the medium P, and the desired image or character can be formed on the medium P.

The control circuit 100 may supply the control signal Ctrl1 for controlling the reciprocating movement of the moving body 2 to the moving unit 3 after performing signal conversion using a carriage motor driver (not illustrated), and may supply the control signal Ctrl2 for controlling the transport of the medium P to the transport unit 4 after performing signal conversion using a transport motor driver (not illustrated).

The control circuit 100 generates a clock signal SCK, a print data signal SI, a latch signal LAT, a base drive signal dA, a waveform information signal WAV, and a drive element number information signal CNT for controlling an operation of the head unit 20, and outputs the clock signal SCK, the print data signal SI, the latch signal LAT, the base drive signal dA, the waveform information signal WAV, and the drive element number information signal CNT to the head unit 20.

The head unit 20 includes a drive circuit 50, a drive signal selection circuit 200, and an ejection head 21. The drive signal selection circuit 200 includes a selection control circuit 210 and a plurality of selection circuits 230. The ejection head 21 includes a plurality of ejection sections 600. Each of the ejection sections 600 includes a piezoelectric element 60. In this case, each of the plurality of selection circuits 230 included in the drive signal selection circuit 200 is provided corresponding to the piezoelectric element 60 included in a corresponding one of the plurality of ejection sections 600 included in the ejection head 21.

The base drive signal dA, the waveform information signal WAV, and the drive element number information signal CNT output by the control unit 10 are input to the drive circuit 50. The base drive signal dA is a digital signal including information defining a signal waveform of a drive signal COM for driving the piezoelectric elements 60 described later. The waveform information signal WAV is waveform information of the drive signal COM to be output, and includes, for example, information of a voltage value of the drive signal COM and information of an amount of change in the voltage value of the drive signal COM per unit time. The drive element number information signal CNT includes information indicating the number of piezoelectric elements 60 that are to be driven by the drive signal COM output by the drive circuit 50 in a dot formation period T described later.

That is, the control circuit 100 outputs the waveform information signal WAV including the waveform information of the drive signal COM and the drive element number information signal CNT including the information indicating the number of piezoelectric elements 60 to be driven by the drive signal COM.

The drive circuit 50 converts the base drive signal dA into an analog signal, amplifies the converted analog signal based on the waveform information signal WAV and the drive element number information signal CNT to generate the drive signal COM, and outputs the generated drive signal COM.

The clock signal SCK, the print data signal SI, and the latch signal LAT output by the control unit 10 are input to the selection control circuit 210 included in the drive signal selection circuit 200. The selection control circuit 210 generates selection signals S for the respective selection circuits 230 based on the clock signal SCK, the print data signal SI, and the latch signal LAT. Each of the selection signals S defines whether to select the drive signal COM. The selection control circuit 210 outputs the generated selection signals S to the corresponding selection circuits 230.

The drive signal COM is input to each of the selection circuits 230, and each of the selection signals S is input to a corresponding one of the selection circuits 230. Each of the plurality of selection circuits 230 generates a drive signal VOUT by selecting or not selecting the drive signal COM based on the selection signal S input to the selection circuit 230. Then, the plurality of selection circuits 230 supply the generated drive signals VOUT to first ends of the piezoelectric elements 60 included in the corresponding ejection sections 600 included in the ejection head 21.

A reference voltage signal VBS is commonly supplied to second ends of the piezoelectric elements 60 included in the plurality of ejection sections 600. The reference voltage signal VBS is a signal that has a constant voltage value and functions as a reference electrical potential for driving the piezoelectric elements 60 by the drive signals VOUT. The reference voltage signal VBS may be, for example, a direct current voltage signal of 5.5 V, 6 V, or the like, or may be a signal having a constant voltage value at a ground electrical potential.

The plurality of piezoelectric elements 60 are provided corresponding to the respective nozzles in the head unit 20. The piezoelectric elements 60 are driven in accordance with differences between the drive signals VOUT supplied to the first ends and the reference voltage signal VBS supplied to the second ends. Ink in an amount corresponding to an amount by which each of the piezoelectric elements 60 is driven is ejected from the ejection section 600 including the piezoelectric element 60.

FIG. 2 illustrates a case where the head unit 20 includes one ejection head 21, but the head unit 20 may include a plurality of ejection heads 21 depending on a type of ink to be ejected, the number of types of ink to be ejected, or the like.

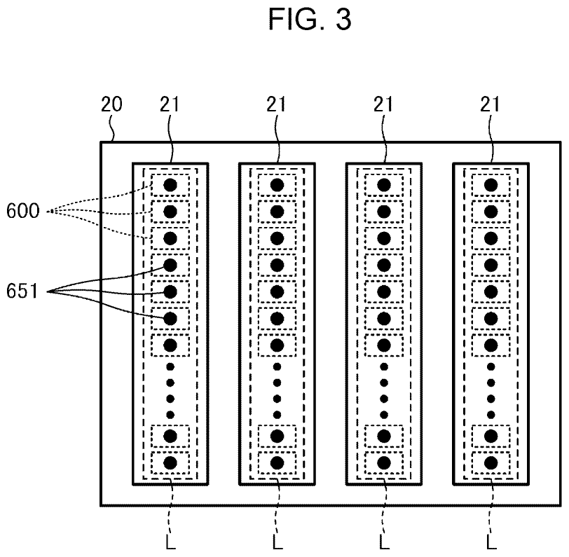

An example of the configuration of the plurality of ejection sections 600 included in the ejection head 21 and the arrangement of the plurality of the ejection sections 600 in the head unit 20 will be described. FIG. 3 is a diagram illustrating an example of the arrangement of the plurality of ejection sections 600 in the head unit 20. FIG. 3 illustrates a case where the head unit 20 includes four ejection heads 21.

As illustrated in FIG. 3, each of the four ejection heads 21 has a plurality of ejection sections 600 arranged in a row in one direction. That is, each of the ejection heads 21 includes a nozzle row L in which nozzles 651 (described later) included in the ejection sections 600 are arranged in one direction. The ejection heads 21 are located side by side in a direction intersecting the nozzle rows L in the head unit 20. That is, the same number of nozzle rows L as the ejection heads 21 are formed in the head unit 20. The arrangement of the nozzles 651 in each of the nozzle rows L is not limited to one row, and for example, the nozzles 651 may be arranged in a staggered manner such that the positions of even-numbered nozzles 651 counted from one end among the plurality of nozzles 651 are different from the positions of odd-numbered nozzles 651 counted from the one end among the plurality of nozzles 651, or each nozzle row L may be formed by arranging a plurality of nozzles 651 in two or more rows.

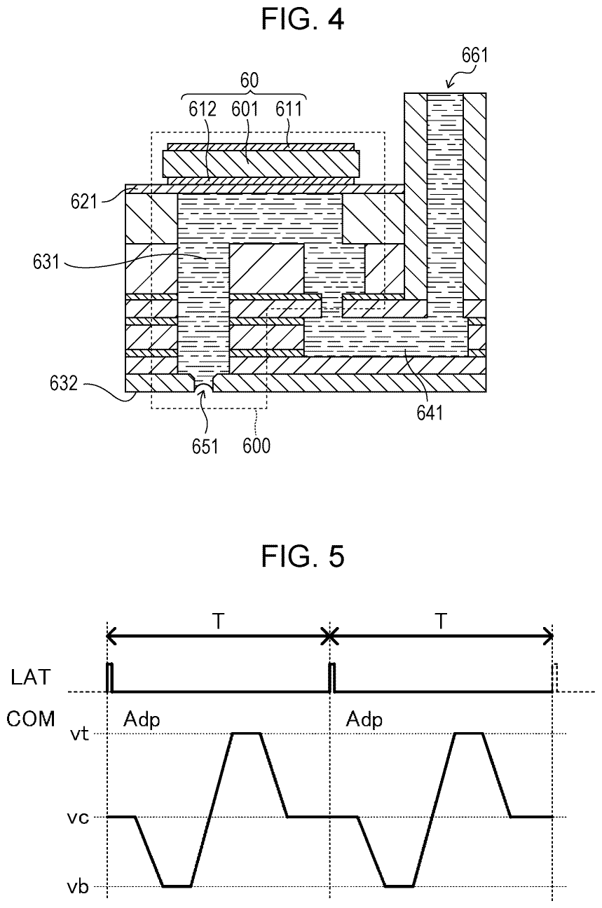

Next, an example of a configuration of each of the ejection sections 600 will be described. FIG. 4 is a diagram illustrating the example of the configuration of the ejection section 600. As illustrated in FIG. 4, each of the ejection sections 600 includes a piezoelectric element 60, a vibration plate 621, a cavity 631, and a nozzle 651. The vibration plate 621 is deformed in accordance with the driving of the piezoelectric element 60 provided on an upper surface of the vibration plate 621 in FIG. 4. The vibration plate 621 functions as a diaphragm that increases and decreases the internal volume of the cavity 631. The inside of the cavity 631 is filled with ink. The cavity 631 functions as a pressure chamber whose internal volume changes by the deformation of the vibration plate 621 caused by the driving of the piezoelectric element 60. The nozzle 651 is an opening formed in a nozzle plate 632 and communicating with the cavity 631. In accordance with the change in the internal volume of the cavity 631, the ink stored in the cavity 631 is ejected from the nozzle 651.

The piezoelectric element 60 has a structure in which a piezoelectric body 601 is disposed between a pair of electrodes 611 and 612. Regarding the piezoelectric body 601 having this structure, central portions of the electrodes 611 and 612 and a central portion of the vibration plate 621 are bent in a vertical direction in FIG. 4 with respect to both end portions of each of the electrodes 611 and 612 and both end portions of the vibration plate 621 in accordance with the difference in electrical potential between the electrode 611 and the electrode 612.

Specifically, a drive signal VOUT is supplied to the electrode 611 that is the first end of the piezoelectric element 60, and the reference voltage signal VBS is supplied to the electrode 612 that is the second end of the piezoelectric element 60. When the piezoelectric element 60 is driven upward in accordance with a change in a voltage of the drive signal VOUT, the vibration plate 621 is deformed upward. As a result, the internal volume of the cavity 631 is increased. Therefore, ink stored in a reservoir 641 is drawn into the cavity 631. On the other hand, when the piezoelectric element 60 is driven downward in accordance with a change in the voltage of the drive signal VOUT, the vibration plate 621 is deformed downward. As a result, the internal volume of the cavity 631 is decreased. Therefore, ink in an amount corresponding to the decrease in the internal volume of the cavity 631 is ejected from the nozzle 651.

As described above, the ejection head 21 includes the piezoelectric elements 60, and ejects ink onto the medium P by driving the piezoelectric elements 60. The ejection sections 600 and the piezoelectric elements 60 included in the ejection sections 600 are not limited to the configuration illustrated in the drawing, and may have a structure in which the piezoelectric elements 60 are driven based on the drive signals VOUT and ink is ejected from the corresponding nozzles 651 by the driving of the piezoelectric elements 60.

As described above, the liquid ejecting apparatus 1 according to the present embodiment includes the ejection head 21 that includes the plurality of piezoelectric elements 60 that are driven when the drive signal COM is supplied to the piezoelectric elements 60, and that ejects ink by driving the plurality of piezoelectric elements 60, the drive circuit 50 that outputs the drive signal COM, and the control circuit 100 that controls the ejection head 21 and the drive circuit 50.

### 2. Configuration and Operation of Drive Signal Selection Circuit

Next, a configuration and an operation of the drive signal selection circuit 200 will be described.

Before description of the configuration and the operation of the drive signal selection circuit 200, first, an example of the signal waveform of the drive signal COM output by the drive circuit 50 and input to the drive signal selection circuit 200 will be described. FIG. 5 is a diagram illustrating an example of the signal waveform of the drive signal COM. As illustrated in FIG. 5, the drive signal COM includes a drive waveform Adp in each dot formation period T from a rising edge of the latch signal LAT to the next rising edge of the latch signal LAT. The drive waveform Adp includes a period of time when the voltage of the drive signal COM is constant at a voltage vc, a period of time when the voltage is constant at a voltage vb lower than the voltage vc after the period of time when the voltage is constant at the voltage vc, a period of time when the voltage is constant at a voltage vt higher than the voltage vc after the period of time when the voltage is constant at the voltage vb, and a period of time when the voltage is constant at the voltage vc after the period of time when the voltage is constant at the voltage vt. That is, the drive signal COM includes the drive waveform Adp in which the voltage changes between the voltage vt and the voltage vb, and that starts at the voltage vc and ends at the voltage vc in the dot formation period T.

The voltage vc corresponds to an electrical potential serving as a reference for deformation of each of the piezoelectric elements 60. When the voltage of the drive signal COM supplied to the piezoelectric element 60 changes from the voltage vc to the voltage vb, the piezoelectric element 60 is driven upward as illustrated in FIG. 4. As a result, the vibration plate 621 is deformed upward as illustrated in FIG. 4. Then, when the vibration plate 621 is deformed upward as illustrated in FIG. 4, the internal volume of the cavity 631 is increased, and the ink is drawn into the cavity 631 from the reservoir 641. Thereafter, when the voltage of the drive signal COM supplied to the piezoelectric element 60 changes from the voltage vb to the voltage vt, the piezoelectric element 60 is driven downward as illustrated in FIG. 4. As a result, the vibration plate 621 is deformed downward as illustrated in FIG. 4. When the vibration plate 621 is deformed downward as illustrated in FIG. 4, the internal volume of the cavity 631 is decreased, and the ink stored in the cavity 631 is ejected from the nozzle 651.

Ink in the vicinity of the nozzle 651 or the vibration plate 621 may continue vibrating for a certain period of time after the ink is ejected from the nozzle 651 by the driving of the piezoelectric element 60. The periods of time when the voltage of the drive signal COM is constant at the voltages vc, vt, and vb also serve as periods of time for stopping the vibration of the ink and the vibration of the vibration plate 621 that do not contribute to the ejection of the ink.

The signal waveform of the drive signal COM illustrated in FIG. 5 is an example, and is not limited thereto. The signal waveform of the drive signal COM may include signal waveforms of various shapes according to the physical properties of the ink that is ejected by the ejection head 21, the length of the dot formation period T, the speed at which the medium P is transported, and the like.

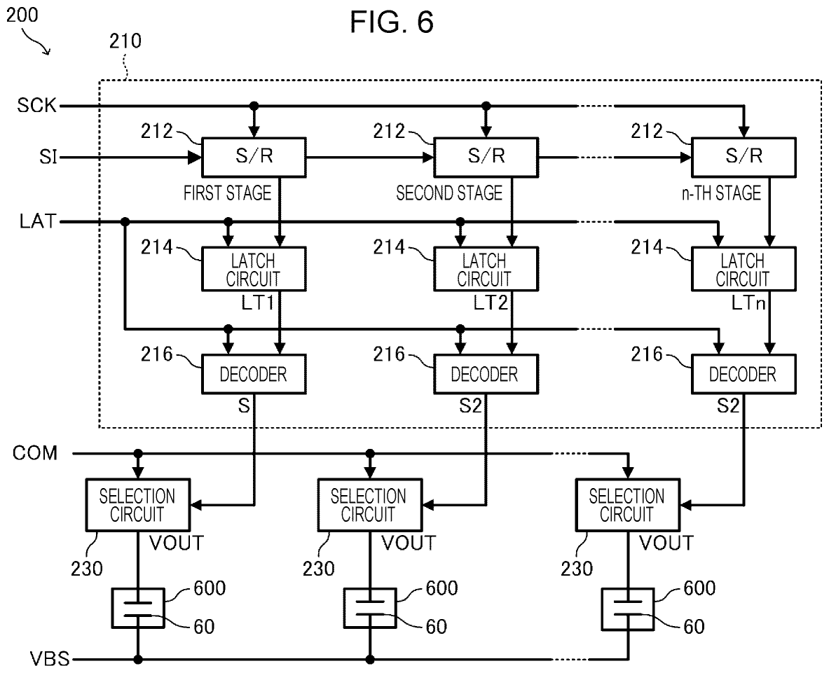

Next, the configuration and the operation of the drive signal selection circuit 200 that generates each of the drive signals VOUT by selecting or not selecting the drive signal COM and outputs the drive signals VOUT to the corresponding ejection sections 600 will be described. FIG. 6 is a diagram illustrating an example of the configuration of the drive signal selection circuit 200.

The drive signal selection circuit 200 includes the selection control circuit 210 and the selection circuits 230. The clock signal SCK, the print data signal SI, and the latch signal LAT are input to the selection control circuit 210. In the selection control circuit 210, a set of a shift register (S/R) 212, a latch circuit 214, and a decoder 216 is provided corresponding to each of the n piezoelectric elements 60. That is, the selection control circuit 210 includes n shift registers 212, n latch circuits 214, and n decoders 216.

The print data signal SI is input to the selection control circuit 210 in synchronization with the clock signal SCK. The print data signal SI serially includes 1-bit print data SId for selecting “ejection Dt” or “non-ejection nDt” for each of the n piezoelectric elements 60. The print data SId included in the print data signal SI is held in the n shift registers 212 corresponding to the n piezoelectric elements 60. Specifically, the n shift registers 212 corresponding to the piezoelectric elements 60 are cascaded to each other, and the print data signal SI input in serial is sequentially transferred to the shift registers 212 at the subsequent stages in accordance with the clock signal SCK. Then, when the print data SId is held in the corresponding shift registers 212, the clock signal SCK is stopped. Accordingly, the print data SId included in the print data signal SI is held in the corresponding shift registers 212. In FIG. 6, in order to distinguish the n shift registers 212 from each other, the first stage, the second stage, - - - , and the n-th stage are illustrated in order from the upstream side on which the print data signal SI is input. In the following description, the print data SId corresponding to the first stage, the second stage, - - -, and the n-th stage may be referred to as print data SId-1, SId-2, - - - , and SId-n.

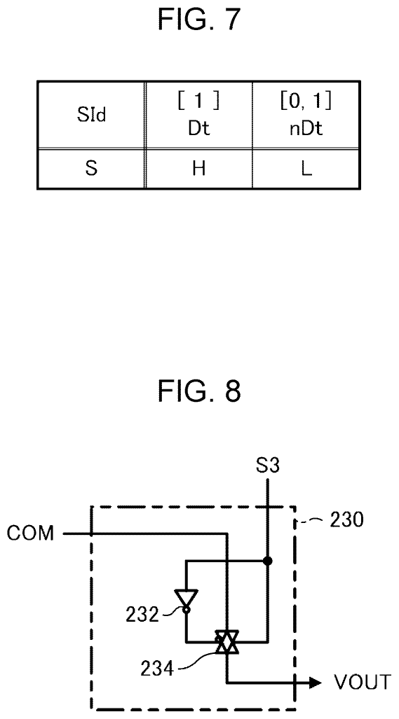

The n latch circuits 214 simultaneously latch the print data SId held in the corresponding shift registers 212 at a rising edge of the latch signal LAT. Then, the print data SId latched by the latch circuits 214 is input to the corresponding decoders 216. FIG. 7 is a diagram illustrating an example of the content of decoding by the decoders 216. Each of the decoders 216 outputs a selection signal S of a logic level defined by the input print data SId in the dot formation period T. Specifically, when print data SId=[1] is input to the decoder 216, the decoder 216 outputs, as an H-level selection signal S, a signal obtained by level-shifting an H-level signal to a high-amplitude logic signal in the dot formation period T. When print data SId=[0] is input to the decoder 216, the decoder 216 outputs, as an L-level selection signal S, a signal obtained by level-shifting an L-level signal to a high-amplitude logic signal in the dot formation period T.

The selection signals S output by the decoders 216 are input to the corresponding selection circuits 230. The selection circuits 230 are provided corresponding to the respective n ejection sections 600. FIG. 8 is a diagram illustrating an example of a configuration of each of the selection circuits 230. As illustrated in FIG. 8, each of the selection circuits 230 includes an inverter 232 and a transfer gate 234. The inverter 232 is a NOT circuit.

A selection signal S is input to a positive control terminal of the transfer gate 234. The positive control terminal is not marked with a circle. After the logic level of the selection signal S is inverted by the inverter 232, a signal obtained by inverting the logic level of the selection signal S is input to a negative control terminal of the transfer gate 234. The negative control terminal is marked with a circle. The drive signal COM is supplied to an input terminal of the transfer gate 234. When an H-level selection signal S is input to the transfer gate 234, the transfer gate 234 becomes conductive between the input terminal and an output terminal of the transfer gate 234. When an L-level selection signal S is input to the transfer gate 234, the transfer gate 234 becomes non-conductive between the input terminal and the output terminal. That is, the transfer gate 234 outputs the drive waveform Adp included in the drive signal COM from the output terminal when the selection signal S is at an H level, and does not output the drive waveform Adp included in the drive signal COM from the output terminal when the selection signal S is at an L level. Then, the signal at the output terminal of the transfer gate 234 is output from the selection circuit 230 as a drive signal VOUT.

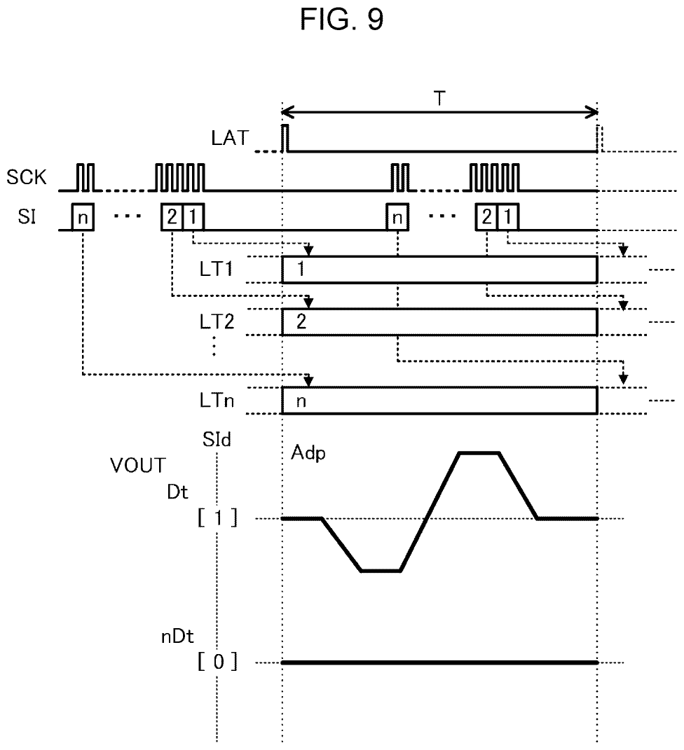

An operation of the drive signal selection circuit 200 will be described. FIG. 9 is a diagram for explaining the operation of the drive signal selection circuit 200. The print data signal SI is input to the selection control circuit 210 as a serial signal serially including the print data SId, and is sequentially transferred to the n shift registers 212 corresponding to the n piezoelectric elements 60 in synchronization with the clock signal SCK. Thereafter, when the supply of the clock signal SCK is stopped, the print data SId corresponding to the n piezoelectric elements 60 is held in the shift registers 212. The print data signal SI is input to the shift registers 212 as a signal including the print data SId in order corresponding to the piezoelectric elements 60 at the n-th stage, - - - , the second stage, and the first stage of the shift registers 212.

Then, when the latch signal LAT rises, the latch circuits 214 simultaneously latch the print data SId held in the shift registers 212. Note that LT1, LT2, - - - , and LTn illustrated in FIG. 9 indicate the print data SId latched by the latch circuits 214 corresponding to the shift registers 212 of the first stage, the second stage, - - - , and the nth stage, respectively. That is, LT1 corresponds to the print data SId-1, and LTn corresponds to the print data SId-n.

Each of the decoders 216 outputs a selection signal S of a logic level defined by the latched print data SId in each dot formation period T. Then, each of the selection circuits 230 generates a drive signal VOUT by selecting or not selecting the drive signal COM in accordance with a logic level of a selection signal S output by a corresponding one of the decoders 216.

Specifically, when the print data SId=[1] is input to the decoder 216, the decoder 216 sets the selection signal S in the dot formation period T to an H level. Accordingly, the selection circuit 230 supplies the drive signal VOUT including the drive waveform Adp to the piezoelectric element 60 included in the corresponding ejection section 600 in the dot formation period T. As a result, ink is ejected from the corresponding ejection section 600. The ink ejected from the ejection section 600 lands on the medium P, thereby forming a dot on the medium P.

When the print data SId=[0] is input to the decoder 216, the decoder 216 sets the selection signal S in the dot formation period T to an L level. Thus, the selection circuit 230 does not output a drive signal VOUT including the drive waveform Adp in the dot formation period T. In this case, a signal of a constant voltage value held by a capacitance component of the piezoelectric element 60 is supplied to the piezoelectric element 60 included in the corresponding ejection section 600. That is, the selection circuit 230 supplies a drive signal VOUT having the constant voltage value to the piezoelectric element 60 included in the corresponding ejection section 600 in the dot formation period T. As a result, the piezoelectric element 60 included in the corresponding ejection section 600 is not driven, and ink is not ejected from the corresponding ejection section 600. Therefore, a dot is not formed on the medium P.

As described above, the drive signal selection circuit 200 generates the drive signals VOUT by selecting or not selecting the drive signal COM output by the drive circuit 50, and outputs the drive signals VOUT to the piezoelectric elements 60 included in the corresponding ejection sections 600.

### 3. Configuration of Drive Circuit

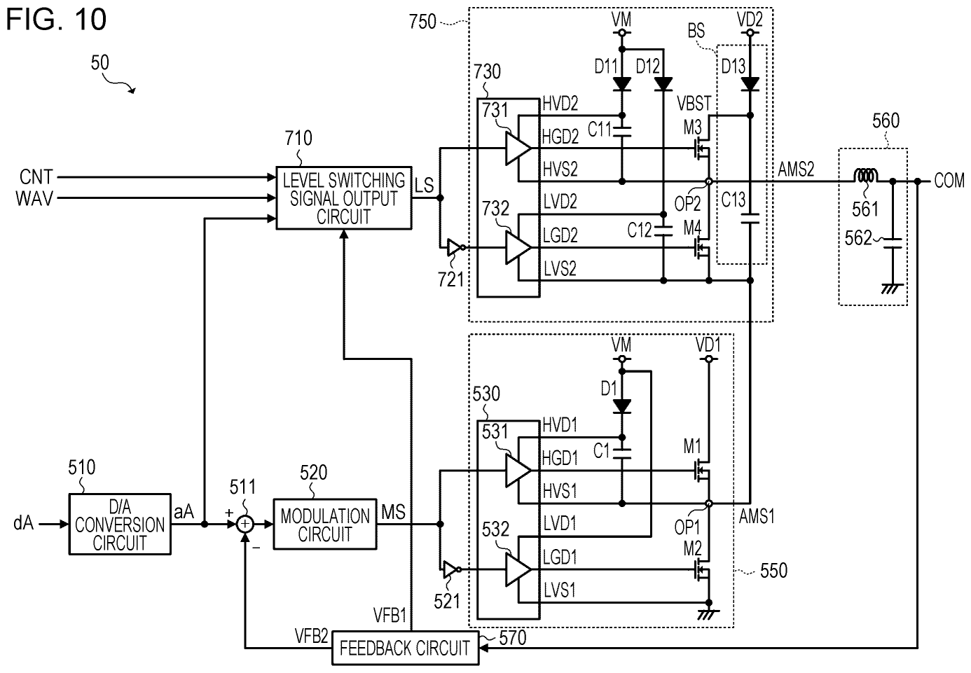

Next, a configuration of the drive circuit 50 will be described. FIG. 10 is a diagram illustrating an example of a functional configuration of the drive circuit 50. As illustrated in FIG. 10, the drive circuit 50 includes a D/A conversion circuit 510, an adder 511, a modulation circuit 520, an inverter 521, an amplifier circuit 550, a demodulation circuit 560, a feedback circuit 570, a level switching signal output circuit 710, and a level shift circuit 750.

The base drive signal dA that is a digital signal is input from the control circuit 100 to the D/A conversion circuit 510. The D/A conversion circuit 510 converts the input base drive signal dA from the digital signal to the analog signal, and then outputs the converted analog signal as a base drive signal aA. The voltage of the base drive signal aA is, for example, in a range from 1 V to 2 V. The drive circuit 50 outputs a signal obtained by amplifying the base drive signal aA as the drive signal COM. That is, the base drive signal aA corresponds to a target signal before the amplification performed to obtain the drive signal COM.

The base drive signal aA is input to a positive input terminal of the adder 511. A feedback signal VFB2 obtained by feeding back the drive signal COM via the feedback circuit 570 (described later) is input to a negative input terminal of the adder 511. The adder 511 outputs a signal obtained by subtracting the feedback signal VFB2 from the base drive signal aA to the modulation circuit 520.

The modulation circuit 520 generates a modulated signal MS by performing pulse modulation on the signal output by the adder 511. Then, the modulation circuit 520 outputs the generated modulated signal MS to the amplifier circuit 550. The modulation circuit 520 generates a pulse density modulated signal (PDM signal) by modulating the signal output by the adder 511 by a pulse density modulation (PDM) method, and outputs the PDM signal as the modulated signal MS to the amplifier circuit 550. Specifically, the modulation circuit 520 compares the voltage of the signal output by the adder 511 with a predetermined reference voltage. Then, the modulation circuit 520 generates the modulated signal MS that is at an H level when the voltage of the signal output by the adder 511 is higher than the reference voltage, and that is at an L level when the voltage of the signal output by the adder 511 is lower than the reference voltage. The modulation circuit 520 outputs the modulated signal MS to the amplifier circuit 550.

The amplifier circuit 550 includes a gate drive circuit 530, a diode D1, a capacitor C1, and transistors M1 and M2. The amplifier circuit 550 generates a first amplified modulated signal AMS1 by amplifying the input modulated signal MS, and outputs the first amplified modulated signal AMS1 from a first output point OP1.

The gate drive circuit 530 outputs a gate drive signal HGD1 and a gate drive signal LGD1 based on the modulated signal MS. Specifically, the modulated signal MS is input to a gate driver 531 included in the gate drive circuit 530. The gate driver 531 generates the gate drive signal HGD1 by level-shifting the input modulated signal MS, and outputs the gate drive signal HGD1 to the transistor M1. After the logic level of the modulated signal MS is inverted by the inverter 521, a signal obtained by inverting the logic level of the modulated signal MS is input to a gate driver 532 included in the gate drive circuit 530. The gate driver 532 generates the gate drive signal LGD1 by level-shifting the signal obtained by inverting the logic level of the input modulated signal MS, and outputs the gate drive signal LGD2 to the transistor M2.

Each of the transistors M1 and M2 is an N-channel MOSFET. The transistor M1 has a source terminal electrically coupled to the first output point OP1, a drain terminal to which a voltage signal VD1 is supplied, and a gate terminal to which the gate drive signal HGD1 is input. The transistor M1 operates based on the gate drive signal HGD1. The transistor M2 has a drain terminal electrically coupled to the first output point OP1, a source terminal to which the ground electrical potential is supplied, and a gate terminal to which the gate drive signal LGD1 is input. The transistor M2 operates based on the gate drive signal LGD1. The transistor M1 operates based on the gate drive signal HGD1, and the transistor M2 operates based on the gate drive signal LGD1, whereby the first amplified modulated signal AMS1 obtained by amplifying the modulated signal MS with a voltage vd1 whose value is equal to the voltage value of the voltage signal VD1 is generated at the first output point OP1. The voltage vd1 has a voltage value of about half the maximum voltage value of the drive signal COM output by the drive circuit 50. For example, in a case where the maximum voltage value of the drive signal COM output by the drive circuit 50 is 40 V, the voltage vd1 is a direct current voltage having a voltage value in a range of 15 V to 25 V.

An operation of the gate drive circuit 530 will be described. The gate drive circuit 530 includes the gate drivers 531 and 532. As described above, the modulated signal MS is input to the gate driver 531, and the signal obtained by inverting the logic level of the modulated signal MS by the inverter 521 is input to the gate driver 532. That is, the signal input to the gate driver 531 and the signal input to the gate driver 532 are exclusively at an H level. The case where the signals are exclusively at an H level includes a case where an H-level signal is not input to the gate driver 531 and the gate driver 532 at the same time. That is, a case where an L-level signal is input to the gate driver 531 and the gate driver 532 at the same time is not excluded.

A power supply terminal of the gate driver 531 on the low electrical potential side of the gate driver 531 is electrically coupled to the first output point OP1. Therefore, the first amplified modulated signal AMS1 generated at the first output point OP1 is supplied to the power supply terminal of the gate driver 531 on the low electrical potential side as a voltage signal HVS1. A power supply terminal of the gate driver 531 on the high electrical potential side of the gate driver 531 is electrically coupled to the cathode terminal of the diode D1 and a first end of the capacitor C1. A voltage signal VM is supplied to the anode terminal of the diode D1. A second end of the capacitor C1 is electrically coupled to the first output point OP1. That is, the diode D1 and the capacitor C1 constitute a bootstrap circuit, and a voltage output from the bootstrap circuit is supplied to the power supply terminal of the gate driver 531 on the high electrical potential side. Therefore, a voltage signal HVD1 having a voltage value higher by a voltage vm whose value is equal to the voltage value of the voltage signal VM than the voltage value of the voltage signal HVS1 input to the power supply terminal of the gate driver 531 on the low electrical potential side is supplied to the power supply terminal of the gate driver 531 on the high electrical potential side.

Therefore, the gate driver 531 outputs a gate drive signal HGD1 based on the voltage signal HVD1 having the voltage value higher than the voltage value of the first output point OP1 by the voltage vm when an H-level modulated signal MS is input to the gate driver 531, and outputs a gate drive signal HGD1 based on the voltage signal HVS1 having the voltage value of the first output point OP1 when an L-level modulated signal MS is input to the gate driver 531. The voltage vm may have a voltage value that enables driving of each of the transistors M1 and M2 and transistors M3 and M4 (described later), and is, for example, a direct-current voltage of 7.5 V.

The ground electrical potential is supplied as a voltage signal LVS1 to a power supply terminal of the gate driver 532 on the low electrical potential side of the gate driver 532. The voltage vm whose value is equal to the voltage value of the voltage signal VM is supplied as a voltage signal LVD1 to a power supply terminal of the gate driver 532 on the high electrical potential side of the gate driver 532. Therefore, the gate driver 532 outputs a gate drive signal LGD1 having a voltage value based on the voltage signal LVD1 having a voltage value equal to the voltage vm when an H-level signal obtained by inverting the logic level of the L-level modulated signal MS by the inverters 521 is input to the gate driver 532. The gate driver 532 outputs a gate drive signal LGD1 having a voltage value based on the voltage signal LVS1 at the ground electrical potential when an L-level signal obtained by inverting the logic level of the H-level modulated signal MS by the inverters 521 is input to the gate driver 532. Then, the transistor M1 operates based on the gate drive signal HGD1, and the transistor M2 operates based on the gate drive signal LGD1, whereby the first amplified modulated signal AMS1 obtained by amplifying the modulated signal MS with the voltage vd1 whose value is equal to the voltage value of the voltage signal VD1 is output from the first output point OP1.

The base drive signal aA, the waveform information signal WAV, the drive element number information signal CNT, and a feedback signal VFB1 output by the feedback circuit 570 (described later) are input to the level switching signal output circuit 710. The level switching signal output circuit 710 outputs a level switching signal LS whose logic level changes based on the input base drive signal aA, the input waveform information signal WAV, the input drive element number information signal CNT, and the input feedback signal VFB1. Specifically, the level switching signal output circuit 710 outputs an H-level level switching signal LS for a period of time when the value of the base drive signal aA is constant and greater than a predetermined threshold, and outputs an L-level level switching signal LS for a period of time when the value of the base drive signal aA is constant and less than the predetermined threshold. Further, the level switching signal output circuit 710 outputs the level switching signal LS whose logic level changes based on the base drive signal aA, the waveform information signal WAV, the drive element number information signal CNT, and the feedback signal VFB1 in a period of time when the value of the base drive signal aA changes and immediately after the value of the base drive signal aA changes and becomes constant. The configuration and the operation of the level switching signal output circuit 710 will be described in detail later.

The level shift circuit 750 includes a gate drive circuit 730, diodes D11 and D12, capacitors C11 and C12, the transistors M3 and M4, and a boost circuit BS. The level shift circuit 750 outputs the first amplified modulated signal AMS1 or a signal obtained by level-shifting a reference electrical potential of the first amplified modulated signal AMS1 as the second amplified modulated signal AMS2 from a second output point OP2 in accordance with the level switching signal LS input to the level shift circuit 750.

The gate drive circuit 730 outputs a gate drive signal HGD2 and a gate drive signal LGD2 based on the level switching signal LS. Specifically, the level switching signal LS is input to a gate driver 731 included in the gate drive circuit 730. The gate driver 731 generates the gate drive signal HGD2 by level-shifting the input level switching signal LS, and outputs the gate drive signal HGD2 to the transistor M3. After the logic level of the level switching signal LS is inverted by the inverter 721, a signal obtained by inverting the logic level of the level switching signal LS is input to a gate driver 732 included in the gate drive circuit 730. The gate driver 732 generates the gate drive signal LGD2 by level-shifting the signal obtained by inverting the logic level of the input level switching signal LS, and outputs the gate drive signal LGD2 to the transistor M4.

Each of the transistors M3 and M4 is an N-channel MOSFET. The transistor M3 has a source terminal electrically coupled to the second output point OP2, a drain terminal to which a voltage signal VBST is supplied, and a gate terminal to which the gate drive signal HGD2 is input. The transistor M3 operates based on the gate drive signal HGD2. The transistor M4 has a drain terminal electrically coupled to the second output point OP2, a source terminal to which the first amplified modulated signal AMS1 is supplied, and a gate terminal to which the gate drive signal LGD2 is input. The transistor M4 operates based on the gate drive signal LGD2. The transistor M3 operates based on the gate drive signal HGD2, and the transistor M4 operates based on the gate drive signal LGD2, whereby the first amplified modulated signal AMS1 or the signal obtained by level-shifting the reference electrical potential of the first amplified modulated signal AMS1 is output from the second output point OP2 as the second amplified modulated signal AMS2.

The boost circuit BS includes a diode D13 and a capacitor C13. The capacitor C13 has a first end electrically coupled to the first output point OP1, and a second end electrically coupled to the drain terminal of the transistor M3. A voltage signal VD2 is supplied to the anode terminal of the diode D13, and the cathode terminal of the diode D13 is electrically coupled to the second end of the capacitor C13 and the drain terminal of the transistor M3. Although FIG. 10 illustrates a case where the boost circuit BS includes one diode D13, the boost circuit BS may include a plurality of diodes D13 coupled in series.

The boost circuit BS generates the voltage signal VBST by adding the voltage value of the first amplified modulated signal AMS1 to a voltage vd2 applied between the first end and the second end of the capacitor 13, and outputs the voltage signal VBST to the drain terminal of the transistor M3. In other words, the boost circuit BS generates the voltage signal VBST by level-shifting the reference electrical potential of the first amplified modulated signal AMS1 by the voltage vd2 whose value is equal to the voltage value of the voltage signal VD2, and outputs the voltage signal VBST to the drain terminal of the transistor M3. Specifically, a signal based on a voltage value obtained by subtracting a forward drop voltage of the diode D13 from the voltage vd2 whose value is equal to the voltage value of the voltage signal VD2 is supplied to the drain terminal of the transistor M3 as the voltage signal VBST. In the following description, it is assumed that the forward drop voltage of the diode D13 is 0 V. The voltage vd2 has a voltage value of about half the maximum voltage value of the drive signal COM output by the drive circuit 50. For example, in a case where the maximum voltage value of the drive signal COM output by the drive circuit 50 is 40 V, the voltage vd2 is a direct current voltage having a voltage value in a range of 15 V to 25 V.

An operation of the gate drive circuit 730 will be described. The gate drive circuit 730 includes the gate drivers 731 and 732. As described above, the level switching signal LS is input to the gate driver 731, and the signal obtained by inverting the logic level of the level switching signal LS by the inverter 721 is input to the gate driver 732. That is, the signal input to the gate driver 731 and the signal input to the gate driver 732 are exclusively at an H level. The case where the signals are exclusively at an H level includes a case where an H-level signal is not input to the gate driver 731 and the gate driver 732 at the same time. That is, a case where an L-level signal is input to the gate driver 731 and the gate driver 732 at the same time is not excluded.

A power supply terminal of the gate driver 731 on the low electrical potential side of the gate driver 731 is electrically coupled to the second output point OP2. Therefore, a signal generated at the second output point OP2 is supplied to the power supply terminal of the gate driver 731 on the low electrical potential side as a voltage signal HVS2. A power supply terminal of the gate driver 731 on the high electrical potential side of the gate driver 731 is electrically coupled to the cathode terminal of the diode D11 and a first end of the capacitor C11. The voltage signal VM is supplied to the anode terminal of the diode D11, and a second end of the capacitor C11 is electrically coupled to the second output point OP2. That is, the diode D11 and the capacitor C11 constitute a bootstrap circuit, and a voltage output from the bootstrap circuit is supplied to the power supply terminal of the gate driver 731 on the high electrical potential side. Therefore, a voltage signal HVD2 having a voltage value higher by the voltage vm than the voltage value of the voltage signal HVS2 input to the power supply terminal of the gate driver 731 on the low electrical potential side is supplied to the power supply terminal of the gate driver 731 on the high electrical potential side.

Therefore, the gate driver 731 outputs a gate drive signal HGD2 based on the voltage signal HVD2 having a voltage value higher by the voltage vm than the voltage value of the second output point OP2 when the H-level level switching signal LS is input to the gate driver 731, and outputs a gate drive signal HGD2 based on the voltage signal HVS2 having the voltage value of the second output point OP2 when the L-level level switching signal LS is input to the gate driver 731.

A power supply terminal of the gate driver 732 on the low electrical potential side of the gate driver 732 is coupled to the first output point OP1. Therefore, the first amplified modulated signal AMS1 output from the first output point OP1 is supplied as a voltage signal LVS2 to the power supply terminal of the gate driver 732 on the low electrical potential side. A power supply terminal of the gate driver 732 on the high electrical potential side of the gate driver 732 is electrically coupled to the cathode terminal of the diode D12 and a first end of the capacitor C12. The voltage signal VM is supplied to the anode terminal of the diode D12, and a second end of the capacitor C12 is electrically coupled to the first output point OP1. That is, the diode D12 and the capacitor C12 constitute a bootstrap circuit, and a voltage output from the bootstrap circuit is supplied to the power supply terminal of the gate driver 732 on the high electrical potential side. Therefore, a voltage signal LVD2 having a voltage value higher by the voltage vm than the voltage value of the voltage signal LVS2 input to the power supply terminal of the gate driver 732 on the low electrical potential side is supplied to the power supply terminal of the gate driver 732 on the high electrical potential side.

Therefore, the gate driver 732 outputs a gate drive signal LGD2 based on the voltage signal LVD2 having a voltage value higher than the voltage value of the first output point OP1 by the voltage vm when an H-level signal obtained by inverting the logic level of the L-level level switching signal LS by the invertor 721 is input to the gate driver 732. The gate driver 732 outputs a gate drive signal LGD2 based on the voltage signal LVS2 having the voltage value of the first output point OP1 when an L-level signal obtained by inverting the logic level of the H-level level switching signal LS by the invertor 721 is input to the gate driver 732.

When the L-level level switching signal LS is input to the level shift circuit 750 configured as described above, the first output point OP1 of the amplifier circuit 550 and the second output point OP2 of the level shift circuit 750 are electrically coupled to each other via the transistor M4. Therefore, when the input level switching signal LS is at an L level, the level shift circuit 750 outputs the first amplified modulated signal AMS1 as the second amplified modulated signal AMS2 from the second output point OP2.

On the other hand, when the H-level level switching signal LS is input to the level shift circuit 750, the first output point OP1 of the amplifier circuit 550 and the second output point OP2 of the level shift circuit 750 are electrically coupled to each other via the boost circuit BS and the transistor M3. Therefore, when the level switching signal LS is at an H level, the level shift circuit 750 outputs, as the second amplified modulated signal AMS2 from the second output point OP2, the voltage signal VBST obtained by level-shifting the reference electrical potential of the first amplified modulated signal AMS1 by the voltage vd2 whose value is equal to the voltage value of the voltage signal VD2.

The second amplified modulated signal AMS2 output by the level shift circuit 750 is input to the demodulation circuit 560. The demodulation circuit 560 demodulates the second amplified modulated signal AMS2 output by the level shift circuit 750 by smoothing the second amplified modulated signal AMS2, and outputs the demodulated signal as the drive signal COM.

The demodulation circuit 560 includes an inductor 561 and a capacitor 562. The inductor 561 has a first end electrically coupled to the second output point OP2. The inductor 561 has a second end electrically coupled to a first end of the capacitor 562. The ground electrical potential is supplied to a second end of the capacitor 562. That is, the inductor 561 and the capacitor 562 constitute a low-pass filter circuit. The second amplified modulated signal AMS2 output from the level shift circuit 750 is smoothed by the low-pass filter circuit. Then, a signal obtained by smoothing the second amplified modulated signal AMS2 is output from the drive circuit 50 as the drive signal COM.

The feedback circuit 570 generates the feedback signal VFB1 corresponding to the drive signal COM generated by the demodulation circuit 560, and outputs the feedback signal VFB1 to the level switching signal output circuit 710. The feedback signal VFB1 output by the feedback circuit 570 is obtained by dividing the drive signal COM by a voltage dividing circuit (not illustrated) and extracting a high-frequency component of a signal obtained by dividing the drive signal COM by a high-pass filter (not illustrated) or the like.

The feedback circuit 570 generates the feedback signal VFB2 corresponding to the drive signal COM generated by the demodulation circuit 560, and outputs the feedback signal VFB2 to the adder 511. The feedback signal VFB2 output by the feedback circuit 570 includes a signal obtained by dividing the drive signal COM, and the signal obtained by dividing the drive signal COM by the voltage dividing circuit (not illustrated) and extracting the high-frequency component of the signal obtained by dividing the drive signal COM by the high-pass filter (not illustrated) or the like. Then, the adder 511 outputs a signal obtained by subtracting the feedback signal VFB2 from the base drive signal aA to the modulation circuit 520, and the modulation circuit 520 outputs the modulated signal MS based on the feedback signal VFB2 in accordance with the output of the adder 511. Thus, the accuracy of the waveform of the drive signal COM output by the drive circuit 50 is improved.

In the feedback circuit 570, a circuit for generating the feedback signal VFB2 and a circuit for generating the feedback signal VFB1 may be partially or entirely configured as a common circuit, or for example, a high-pass filter for generating the feedback signal VFB2 and a high-pass filter for generating the feedback signal VFB1 may be a common circuit. Needless to say, all of the circuit for generating the feedback signal VFB2 and the circuit for generating the feedback signal VFB1 may be constituted by different circuits.

As described above, the drive circuit 50 includes the modulation circuit 520 that outputs the modulated signal MS obtained by modulating the base drive signal aA corresponding to the base drive signal dA on which the drive signal COM is based, the amplifier circuit 550 that outputs the first amplified modulated signal AMS1 obtained by amplifying the modulated signal MS, the level switching signal output circuit 710 that outputs the level switching signal LS that changes between an H level and an L level, the level shift circuit 750 that outputs, as the second amplified modulated signal AMS2, the signal obtained by shifting the reference electrical potential of the first amplified modulated signal AMS1 when the level switching signal LS is at an H level, and that outputs the first amplified modulated signal AMS1 as the second amplified modulated signal AMS2 when the level switching signal LS is at an L level, the demodulation circuit 560 that demodulates the second amplified modulated signal AMS2 and outputs the drive signal COM, and the feedback circuit 570 that outputs the feedback signals VFB1 and VFB2 corresponding to the drive signal COM. The level shift circuit 750 included in the drive circuit 50 includes the gate drive circuit 730 that outputs the gate drive signal HGD2 and the gate drive signal LGD2 in accordance with the level switching signal LS, the transistor M3 in which a conduction state between the drain terminal and the source terminal is controlled in accordance with the gate drive signal HGD2, the transistor M4 in which a conduction state between the drain terminal and the source terminal is controlled in accordance with the gate drive signal LGD2, and the boost circuit BS to which the first amplified modulated signal AMS1 and the voltage signal VD2 are input, and that outputs the voltage signal VBST obtained by shifting the reference electrical potential of the first amplified modulated signal AMS1 in accordance with the voltage signal VD2. The voltage signal VBST is input to the drain terminal of the transistor M3. The first amplified modulated signal AMS1 is input to the source terminal of the transistor M4. The source terminal of the transistor M3 and the drain terminal of the transistor M4 are electrically coupled at the second output point OP2. When the level switching signal LS is at an H level, the gate drive circuit 730 outputs the gate drive signal HGD2 for controlling the transistor M3 to be conductive between the drain terminal and the source terminal of the transistor M3. When the level switching signal LS is at an L level, the gate drive circuit 730 outputs the gate drive signal LGD2 for controlling the transistor M4 to be conductive between the drain terminal and the source terminal of the transistor M4. The level shift circuit 750 outputs a signal at the second output point OP2 as the second amplified modulated signal AMS2.

### 4. Operation of Drive Circuit

### 4.1 Operation of Drive Circuit

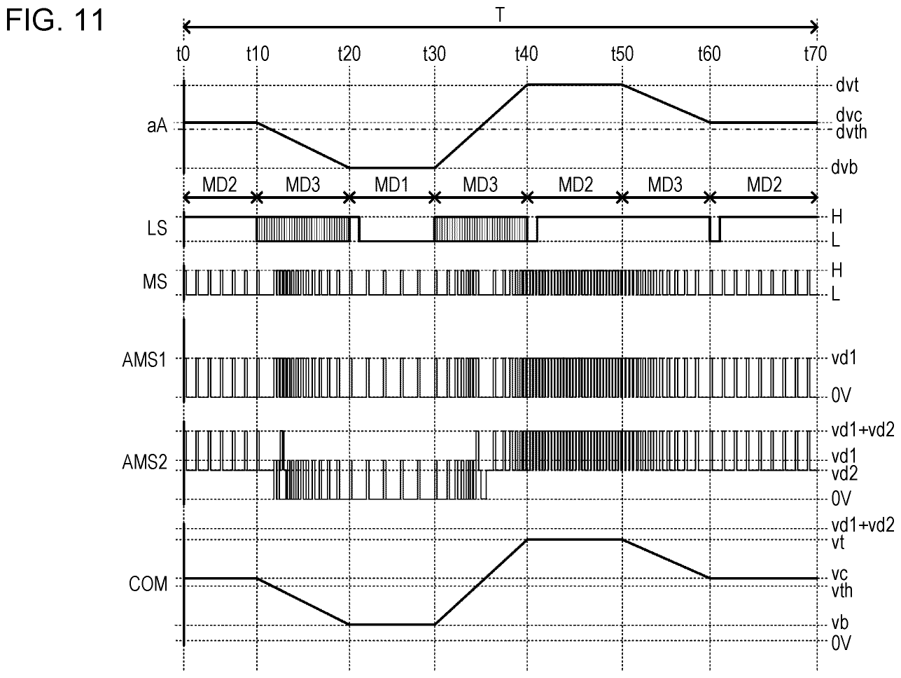

Next, an operation of the drive circuit 50 will be described. FIG. 11 is a diagram for explaining the operation of the drive circuit 50. FIG. 11 illustrates only a drive signal COM in any dot formation period T among drive signals COM output by the drive circuit 50. For convenience of illustration and description, FIG. 11 illustrates signal waveforms in an ideal case where there is no circuit delay or wiring delay. FIG. 11 illustrates a threshold dvth for the base drive signal aA for switching the logic level of the level switching signal LS output by the level switching signal output circuit 710, and a voltage value of the drive signal COM corresponding to the threshold dvth as a voltage vth. FIG. 11 illustrates, as voltages dvt, dvb, and dvc, values of the base drive signal aA corresponding to voltages vt, vb, and vc whose values are voltage values of the drive signal COM. FIG. 11 illustrates a case where the voltage vth is lower than the voltage vc and the threshold dvth is lower than the voltage dvc. However, the voltage vth may be higher than the voltage vc and the threshold dvth may be higher than the voltage dvc.

In the following description, an operation mode of the drive circuit 50 in a period of time when the level switching signal output circuit 710 outputs the L-level level switching signal LS, the level shift circuit 750 outputs the first amplified modulated signal AMS1 as the second amplified modulated signal AMS2, and the value of the base drive signal aA is constant may be referred to as a first mode MD1, and an operation mode of the drive circuit 50 in a period of time when the level switching signal output circuit 710 outputs the H-level level switching signal LS, the level shift circuit 750 outputs, as the second amplified modulated signal AMS2, the signal obtained by level-shifting the reference electrical potential of the first amplified modulated signal AMS1, and the value of the base drive signal aA is constant may be referred to as a second mode MD2, and an operation mode of the drive circuit 50 in a period of time when the value of the base drive signal aA changes regardless of the logic level of the level switching signal LS output by the level switching signal output circuit 710 may be referred to as a third mode MD3.

As illustrated in FIG. 11, during a period of time from time t0 to time t10, the D/A conversion circuit 510 outputs the base drive signal aA having a voltage value greater than the threshold dvth and constant at the voltage dvc in accordance with the input base drive signal dA, and the drive circuit 50 outputs the drive signal COM having a voltage value greater than the voltage vth and constant at the voltage vc in accordance with the base drive signal dA and the base drive signal aA. That is, for the period of time from time t0 to time t10, the operation mode of the drive circuit 50 is the second mode MD2.

During a period of time from time t10 to time t20, the D/A conversion circuit 510 outputs the base drive signal aA having a voltage value that changes from the voltage dvc to a voltage lower than the threshold dvth to the voltage dvb in accordance with the input base drive signal dA, and the drive circuit 50 outputs the drive signal COM having a voltage value that changes from the voltage vc to a voltage lower than the voltage vth to the voltage vb in accordance with the base drive signal dA and the base drive signal aA. That is, for the period of time from time t10 to time t20, the operation mode of the drive circuit 50 is the third mode MD3.

During a period of time from time t20 to time t30, the D/A conversion circuit 510 outputs the base drive signal aA having a voltage value less than the threshold dvth and constant at the voltage dvb in accordance with the input base drive signal dA, and the drive circuit 50 outputs the drive signal COM having a voltage value less than the voltage vth and constant at the voltage vb in accordance with the base drive signal dA and the base drive signal aA. That is, for the period of time from time t20 to time t30, the operation mode of the drive circuit 50 is the first mode MD1.

During a period of time from time t30 to time t40, the D/A conversion circuit 510 outputs the base drive signal aA having a voltage value that changes from the voltage dvb to a voltage higher than the threshold dvth to the voltage dvt in accordance with the input base drive signal dA, and the drive circuit 50 outputs the drive signal COM having a voltage value that changes from the voltage vb to a voltage higher than the voltage vth to the voltage vt in accordance with the base drive signal dA and the base drive signal aA. That is, for the period of time from time t30 to time t40, the operation mode of the drive circuit 50 is the third mode MD3.

During a period of time from time t40 to time t50, the D/A conversion circuit 510 outputs the base drive signal aA having a voltage value greater than the threshold dvth and constant at the voltage dvt in accordance with the input base drive signal dA, and the drive circuit 50 outputs the drive signal COM having a voltage value greater than the voltage vth and constant at the voltage vt in accordance with the base drive signal dA and the base drive signal aA. That is, for the period of time from time t40 to time t50, the operation mode of the drive circuit 50 is the second mode MD2.

During a period of time from time t50 to time t60, the D/A conversion circuit 510 outputs the base drive signal aA having a voltage value that changes from the voltage dvt to the voltage dvc in accordance with the input base drive signal dA, and the drive circuit 50 outputs the drive signal COM having a voltage value that changes from the voltage vt to the voltage vc in accordance with the base drive signal dA and the base drive signal aA. That is, for the period from time t50 to time t60, the operation mode of the drive circuit 50 is the third mode MD3.

During a period of time from time t60 to time t70, the D/A conversion circuit 510 outputs the base drive signal aA having a voltage value greater than the threshold dvth and constant at the voltage dvc in accordance with the input base drive signal dA, and the drive circuit 50 outputs the drive signal COM having a voltage value greater than the voltage vth and constant at the voltage vc in accordance with the base drive signal dA and the base drive signal aA. That is, for the period of time from time t60 to time t70, the operation mode of the drive circuit 50 is the second mode MD2.

Time t70 corresponds to time to described above, and a period of time from time t0 to time t70 corresponds to the dot formation period T. Then, the operation mode of the drive circuit 50 is switched to the first mode MD1, the second mode MD2, and the third mode MD3 in accordance with the input base drive signals dA and aA.

The operation of the drive circuit 50 in each of the operation modes will be described.

In the first mode MD1, the D/A conversion circuit 510 outputs the base drive signal aA having the constant voltage value less than the threshold dvth. In this case, since the voltage value of the base drive signal aA input to the modulation circuit 520 is constant and the voltage value of the drive signal COM output by the drive circuit 50 is constant, the modulation circuit 520 outputs the modulated signal MS having a substantially constant duty ratio. Therefore, the amplifier circuit 550 amplifies the modulated signal MS based on the voltage vd1 to generate the first amplified modulated signal AMS1 having a substantially constant duty ratio and outputs the first amplified modulated signal AMS1.

In the first mode MD1, since the D/A conversion circuit 510 outputs the base drive signal aA whose voltage value is constant and less than the threshold dvth, the level switching signal output circuit 710 outputs the L-level level switching signal LS. Therefore, the level shift circuit 750 outputs the first amplified modulated signal AMS1 as the second amplified modulated signal AMS2. That is, in the first mode MD1, the level shift circuit 750 outputs the first amplified modulated signal AMS1 having the substantially constant duty ratio as the second amplified modulated signal AMS2. Then, the second amplified modulated signal AMS2 output by the level shift circuit 750 is smoothed by the demodulation circuit 560, and thus, in the first mode MD1, the drive circuit 50 outputs the drive signal COM having a constant voltage value less than the voltage vth.

In the second mode MD2, the D/A conversion circuit 510 outputs the base drive signal aA having a constant voltage value greater than the threshold dvth. In this case, since the voltage value of the base drive signal aA input to the modulation circuit 520 is constant and the voltage value of the drive signal COM output by the drive circuit 50 is constant, the modulation circuit 520 outputs the modulated signal MS having a substantially constant duty ratio. Therefore, the amplifier circuit 550 amplifies the modulated signal MS based on the voltage vd1 to generate the first amplified modulated signal AMS1 having the substantially constant duty ratio and outputs the first amplified modulated signal AMS1.

In the second mode MD2, since the D/A conversion circuit 510 outputs the base drive signal aA having a constant voltage value greater than the threshold dvth, the level switching signal output circuit 710 outputs the H-level level switching signal LS. Therefore, the level shift circuit 750 outputs, as the second amplified modulated signal AMS2, the signal obtained by level-shifting the reference electrical potential of the first amplified modulated signal AMS1 by the voltage vd2. That is, in the second mode MD2, the level shift circuit 750 outputs, as the second amplified modulated signal AMS2, the signal obtained by level-shifting the reference electrical potential of the first amplified modulated signal AMS1 having a substantially constant duty ratio from the ground electrical potential to the voltage vd2. Then, the second amplified modulated signal AMS2 output by the level shift circuit 750 is smoothed by the demodulation circuit 560, and thus, in the second mode MD2, the drive circuit 50 outputs the drive signal COM having a constant voltage value greater than the voltage vth.

In the third mode MD3, the D/A conversion circuit 510 outputs the base drive signal aA having a voltage value that changes. In this case, the modulation circuit 520 outputs the modulated signal MS having a duty ratio that changes based on the difference between the voltage value of the input changing base drive signal aA and the feedback signal VFB2 corresponding to the drive signal COM output by the drive circuit 50. Therefore, the amplifier circuit 550 amplifies the modulated signal MS based on the voltage vd1 to generate the first amplified modulated signal AMS1 having the duty ratio that changes based on the difference between the changing voltage value of the base drive signal aA and the feedback signal VFB2, and outputs the first amplified modulated signal AMS1.

In the third mode MD3 in which the voltage value of the base drive signal aA changes, when both the voltage value of the base drive signal aA before the change and the voltage value of the base drive signal aA after the change are less than the threshold dvth, the level switching signal output circuit 710 continues outputting the L-level level switching signal LS. In this case, the level shift circuit 750 outputs, as the second amplified modulated signal AMS2, the first amplified modulated signal AMS1 having the duty ratio that changes in accordance with the change in the base drive signal aA. Then, the second amplified modulated signal AMS2 output by the level shift circuit 750 is smoothed by the demodulation circuit 560, and thus the drive circuit 50 outputs the drive signal COM whose voltage value changes in a state of being less than the voltage vth in accordance with the change in the voltage value of the base drive signal aA. In the third mode MD3 in which the voltage value of the base drive signal aA changes, when both the voltage value of the base drive signal aA before the change and the voltage value of the base drive signal aA after the change are less than the threshold dvth, the level switching signal output circuit 710 may output the level switching signal LS whose logic level changes based on the base drive signal aA and the feedback signal VFB1.

In the third mode MD3 in which the voltage value of the base drive signal aA changes, when both the voltage value of the base drive signal aA before the change and the voltage value of the base drive signal aA after the change are greater than the threshold dvth, the level switching signal output circuit 710 continues outputting the H-level level switching signal LS. In this case, the level shift circuit 750 outputs, as the second amplified modulated signal AMS2, the signal obtained by level-shifting, by the voltage vd2, the reference electrical potential of the first amplified modulated signal AMS1 having the duty ratio that changes in accordance with the change in the base drive signal aA. Then, the second amplified modulated signal AMS2 output by the level shift circuit 750 is smoothed by the demodulation circuit 560, and thus the drive circuit 50 outputs the drive signal COM whose voltage value changes in a state of being greater than the voltage vth in accordance with the change in the voltage value of the base drive signal aA. In the third mode MD3 in which the voltage value of the base drive signal aA changes, when both the voltage value of the base drive signal aA before the change and the voltage value of the base drive signal aA after the change are greater than the threshold dvth, the level switching signal output circuit 710 may output the level switching signal LS whose logic level changes based on the base drive signal aA and the feedback signal VFB1.

In the third mode MD3 in which the voltage value of the base drive signal aA changes, when the voltage value of the base drive signal aA before the change is less than the threshold dvth and the voltage value of the base drive signal aA after the change is greater than the threshold dvth, and when the voltage value of the base drive signal aA before the change is greater than the threshold dvth and the voltage value of the base drive signal aA after the change is less than the threshold dvth, that is, when the voltage value of the base drive signal aA changes to a value greater than the threshold dvth after passing through the threshold dvth and when the voltage value of the base drive signal aA changes to a value less than the threshold dvth after passing through the threshold dvth, the level switching signal output circuit 710 outputs the level switching signal LS whose logic level changes based on the base drive signal aA and the feedback signal VFB1. In this case, the level shift circuit 750 outputs the second amplified modulated signal AMS2 in which the reference electrical potential of the first amplified modulated signal AMS1 having the duty ratio that changes in accordance with the change in the base drive signal aA changes between the ground electrical potential and the voltage vd2 based on the base drive signal aA and the feedback signal VFB1. Then, the second amplified modulated signal AMS2 output by the level shift circuit 750 is smoothed by the demodulation circuit 560, and thus the drive circuit 50 outputs the drive signal COM whose voltage value changes to a value greater than the voltage vth after passing through the voltage vth and changes to a value less than the voltage vth after passing through the voltage vth in accordance with the change in the voltage value of the base drive signal aA.

If the level switching signal output circuit 710 changes the logic level of the level switching signal LS to be output, in accordance with only a result of comparing the value of the base drive signal aA with the threshold dvth when the voltage value of the base drive signal aA changes to a value greater than or less than the threshold dvth after passing through the threshold dvth, the reference electrical potential of the second amplified modulated signal AMS2 output by the level shift circuit 750 steeply changes from the ground electrical potential to the voltage vd2 or from the voltage vd2 to the ground electrical potential. If the response speed of the drive circuit 50 cannot follow the sharp change in the reference electrical potential, the signal waveform of the drive signal COM may be distorted, and the accuracy of the waveform of the drive signal COM may be reduced. On the other hand, in the drive circuit 50 according to the present embodiment, the level switching signal output circuit 710 generates the level switching signal LS using the feedback signal VFB2 obtained by feeding back the drive signal COM together with the base drive signal aA, thereby reducing the possibility that the reference electrical potential of the second amplified modulated signal AMS2 output by the level shift circuit 750 may steeply change, and reducing the possibility that the accuracy of the waveform of the drive signal COM may be reduced.

In the liquid ejecting apparatus 1 according to the present embodiment, immediately after the operation mode of the drive circuit 50 is shifted from the third mode MD3 to the first mode MD1, the level switching signal output circuit 710 sets the logic level of the output level switching signal LS to an H level for a predetermined period of time and then to an L level, and immediately after the operation mode of the drive circuit 50 is shifted from the third mode MD3 to the second mode MD2, the level switching signal output circuit 710 sets the logic level of the output level switching signal LS to an L level for a predetermined period of time and then to an H level, thereby reducing the possibility that undershoot and overshoot may be superimposed on the drive signal COM when the voltage value of the drive signal COM changes from a changing value to a constant value.

### 4.2 Configuration and Operation of Level Switching Signal Output Circuit

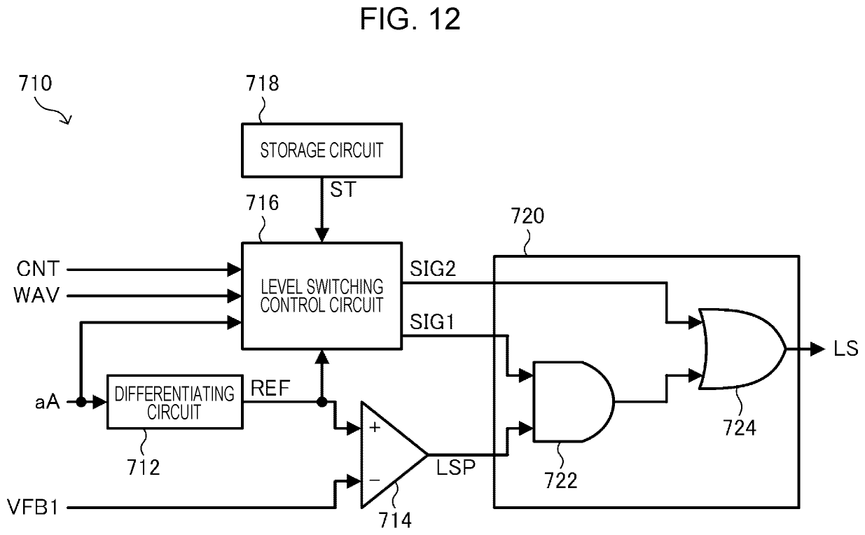

An example of a configuration of the level switching signal output circuit 710 will be described. FIG. 12 is a diagram illustrating the example of the configuration of the level switching signal output circuit 710. As illustrated in FIG. 12, the level switching signal output circuit 710 includes a differentiating circuit 712, a comparing circuit 714, a level switching control circuit 716, a storage circuit 718, and an output switching circuit 720.

The base drive signal aA is input to the differentiating circuit 712. The differentiating circuit 712 outputs, as a reference signal REF to the comparing circuit 714, a signal that corresponds to a change in the voltage value of the input base drive signal aA over time and is obtained by differentiating the input base drive signal aA. The differentiating circuit 712 may include a capacitor element and a resistor element, or may include an operational amplifier or the like.

The comparing circuit 714 includes, for example, a comparator or the like. The reference signal REF output by the differentiating circuit 712 is input to a positive input terminal of the comparing circuit 714. The feedback signal VFB1 is input to a negative input terminal of the comparing circuit 714. The comparing circuit 714 compares the voltage value of the reference signal REF with the voltage value of the feedback signal VFB1. The comparing circuit 714 generates a pulse signal LSP that is at an H level when the voltage value of the reference signal REF is greater than the voltage value of the feedback signal VFB1, and that is at an L level when the voltage value of the reference signal REF is less than the voltage value of the feedback signal VFB1. The comparing circuit 714 outputs the generated pulse signal LSP to the output switching circuit 720.

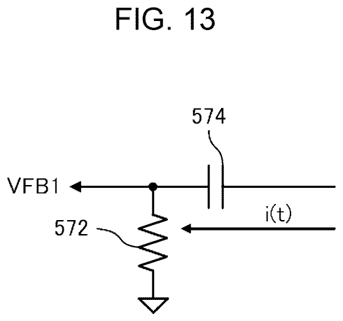

A relationship between the reference signal REF and the feedback signal VFB1 input to the comparing circuit 714 will be described. FIG. 13 is a diagram illustrating an example of a configuration of the high-pass filter included in the feedback circuit 570. As illustrated in FIG. 13, the high-pass filter included in the feedback circuit 570 includes a resistor 572 and a capacitor 574. The signal obtained by dividing the voltage value of the drive signal COM is input to the high-pass filter. In the high pass filter, when the electrostatic capacitance of the capacitor 574 is a capacitance value C, the resistance value of the resistor 572 is a resistance value R, and a current that flows through the capacitor 574 is i(t), a proportional relationship is established between the drive signal COM and the base drive signal aA in a case where a voltage vfb1 whose value is equal to the voltage value of the feedback signal VFB1 satisfies Equation (1). In Equation (1), a is a constant, and v(t) is the voltage value of the base drive signal aA.

$$vfb = i ( t ) \cdot R = α RC \frac{v ( t )}{dt} ( 1 - {e}^{\frac{1}{RC} t} ) \qquad ( 1 )$$

In the high-pass filter, when the product RC of the resistance value R and the capacitance value C is set to be sufficiently less than a period tx of time when the voltage v(t) changes, the feedback signal VFB1 can be treated as a signal including a so-called rectangular wave in which the voltage vfb1 corresponding to the amount of change in the voltage v(t) is generated when the voltage v (t) whose value is equal to the voltage value of the base drive signal aA changes. The case where the product RC of the resistance value R and the capacitance value C is sufficiently less than the period tx of time when the voltage v(t) changes includes, for example, a case where the product RC is equal to or less than 100×10⁻⁹ when the period tx of time is about 1 μs.

Then, when the voltage value of the rectangular wave based on the feedback signal VFB1 obtained by making the product RC of the resistance value R and the capacitance value C sufficiently less than the period tx of time when the voltage v(t) changes is defined as a voltage vb, the voltage vb can be expressed by Equation (2). In Equation (2), a voltage va is the amount of change in the voltage of the base drive signal aA in the period tx of time.

$$vb = α RC \frac{v a}{t x} \qquad ( 2 )$$

That is, the feedback signal VFB1 can be treated as a rectangular wave by making the product RC of the resistance value R and the capacitance value C sufficiently less than the period tx of time when the voltage v(t) changes, and the voltage vb having the voltage value of the rectangular wave is proportional to the voltage va that is the amount of change in the voltage of the base drive signal aA in the period tx of time. Therefore, the reference signal REF, which corresponds to a change over time in the voltage value of the base drive signal aA output by the differentiating circuit 712 and is obtained by differentiating the base drive signal aA, is proportional to the feedback signal VFB1.

The comparing circuit 714 compares the voltage value of the reference signal REF with the voltage value of the feedback signal VFB1 based on the proportional coefficient, and outputs the pulse signal LSP having a logic level corresponding to a result of the comparison. The use of the proportional coefficient between the voltage value of the reference signal REF and the voltage value of the feedback signal VFB1 may be to correct at least one of the voltage value of the reference signal REF or the voltage value of the feedback signal VFB1 corresponding to the voltage value of the reference signal REF based on the proportional coefficient, or to adjust the voltage division ratio of the drive signal COM in the feedback circuit 570.

Referring back to FIG. 12, the storage circuit 718 stores timing information ST that defines the timing of switching logic levels of level switching control signals SIG1 and SIG2 output by the level switching control circuit 716 (described later).

The reference signal REF, the base drive signal aA, the waveform information signal WAV, and the drive element number information signal CNT are input to the level switching control circuit 716. The level switching control circuit 716 acquires the timing information ST from the storage circuit 718 in accordance with the input waveform information signal WAV and the input drive element number information signal CNT.

The level switching control circuit 716 determines, based on the input base drive signal aA, the operation mode of the drive circuit 50 by determining whether the value of the base drive signal aA is greater than or less than a predetermined threshold, and whether the value of the base drive signal aA is constant or changing. Then, the level switching control circuit 716 generates the level switching control signal SIG1 and SIG2 whose logic levels are switched based on the determined operation mode of the drive circuit 50 and the acquired timing information ST, and outputs the level switching control signals SIG1 and SIG2 to the output switching circuit 720.

The output switching circuit 720 includes an AND circuit 722 and an OR circuit 724. The level switching control signals SIG1 and SIG2 and the pulse signal LSP are input to the output switching circuit 720. The output switching circuit 720 generates a level switching signal LS corresponding to the level switching control signals SIG1 and SIG2 and the pulse signal LSP, and outputs the level switching signal LS to the level shift circuit 750.

The level switching control signal SIG1 and the pulse signal LSP are input to the AND circuit 722. The AND circuit 722 outputs an L-level signal when the level switching control signal SIG1 is at an L level, and outputs a signal whose logic level is switched in accordance with the pulse signal LSP when the level switching control signal SIG1 is at an H level. The level switching control signal SIG2 and a signal output by the AND circuit 722 are input to the OR circuit 724. The OR circuit 724 outputs the signal output by the AND circuit 722 when the level switching control signal SIG2 is at an L level, and outputs an H-level signal when the level switching control signal SIG2 is at an H level. A signal output by the OR circuit 724 is output as the level switching signal LS from the level switching signal output circuit 710. That is, the level switching circuit 720 outputs the H-level level switching signal LS when the level switching control signal SIG1 is at an H level and the level switching control signal SIG2 is at an H level, outputs the pulse signal LSP as the level switching signal LS when the level switching control signal SIG1 is at an H level and the level switching control signal SIG2 is at an L level, outputs the H-level level switching signal LS when the level switching control signal SIG is at an L level and the level switching control signal SIG2 is at an H level, and outputs the L-level level switching signal LS when the level switching control signal SIG1 is at an L level and the level switching control signal SIG2 is at an L level.

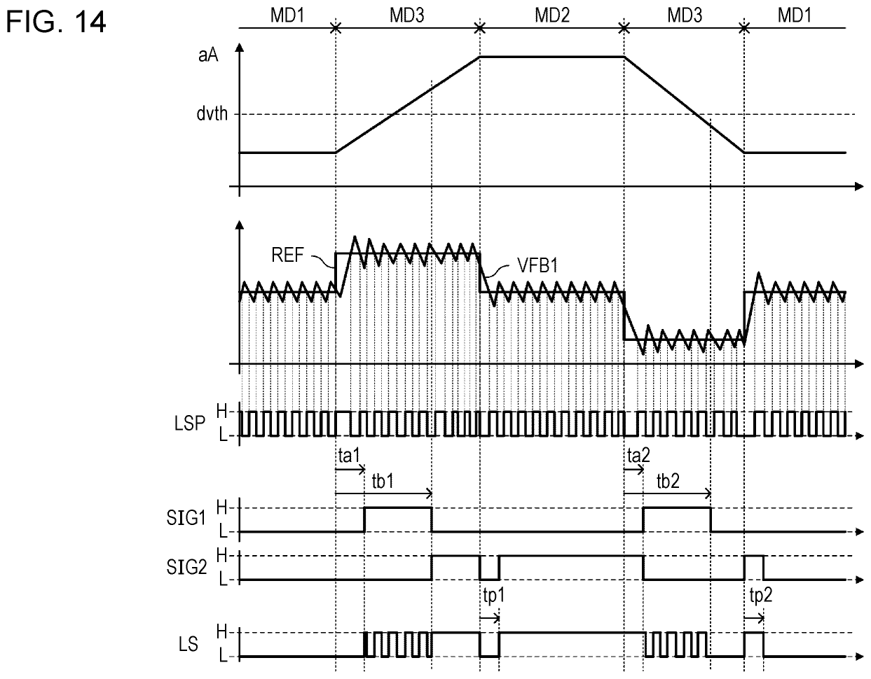

An operation of the level switching signal output circuit 710 will be described. FIG. 14 is a diagram for explaining the operation of the level switching signal output circuit 710. FIG. 14 illustrates an example of the operation of the level switching signal output circuit 710 in a case where the voltage value of the base drive signal aA changes to a value greater than or less than the threshold dvth after passing through the threshold dvth in the third mode MD3, and illustrates the operation of the level switching signal output circuit 710 in a case where the operation mode of the drive circuit 50 is shifted from the first mode MD1 to the second mode MD2 or from the second mode MD2 to the first mode MD1 before and after the third mode MD3.

The comparing circuit 714 compares the voltage value of the reference signal REF with the voltage value of the feedback signal VFB1. Then, the comparing circuit 714 outputs a pulse signal LSP that is at an H level when the voltage value of the reference signal REF is higher than the voltage value of the feedback signal VFB1, and that is at an L level when the voltage value of the reference signal REF is lower than the voltage value of the feedback signal VFB1.

The level switching control circuit 716 acquires the input waveform information signal WAV, and acquires, as the timing information ST corresponding to the drive element number information signal CNT, measurement time ta1 and ta2 that define the timing of controlling the logic level of the level switching control signal SIG1 in the third mode MD3 immediately before shifting to the second mode MD2 from the first mode MD1 and shifting to the first mode MD1 from the second mode MD2, measurement time tb1 and tb2 that define the timing of controlling the logic level of the level switching control signal SIG2 in the third mode MD3 immediately before shifting to the second mode MD2 from the first mode MD1 and shifting to the first mode MD1 from the second mode MD2, measurement time tp1 that defines the timing of controlling the logic levels of the level switching control signals SIG1 and SIG2 immediately after shifting from the third mode MD3 to the second mode MD2, and measurement time tp2 that defines the timing of controlling the logic levels of the level switching control signals SIG1 and SIG2 immediately after shifting from the third mode MD3 to the first mode MD1. Then, the level switching control circuit 716 outputs the level switching control signals SIG1 and SIG2 whose logic levels change in accordance with the acquired measured time ta1, ta2, tb1, tb2, tp1, and tp2, the reference signal REF, and the base drive signal aA.

Specifically, in the third mode MD3 immediately before the operation mode of the drive circuit 50 is shifted to the second mode MD2 from the first mode MD1, the voltage value of the base drive signal aA increases. In this case, the level switching control circuit 716 detects the increase in the voltage value of the base drive signal aA, that is, a rising edge of the reference signal REF, thereby detecting that the operation mode of the drive circuit 50 has been shifted from the first mode MD1 to the third mode MD3. Then, the level switching control circuit 716 starts measuring time elapsed from the shifting of the operation mode of the drive circuit 50 to the third mode MD3.

The level switching control circuit 716 detects the voltage value of the base drive signal aA immediately before or immediately after the operation mode of the drive circuit 50 is shifted from the first mode MD1 to the third mode MD3. In this case, the voltage value of the base drive signal aA is less than the threshold dvth since the operation mode of the drive circuit 50 is the first mode MD1 or is immediately after the operation mode is shifted from the first mode MD1 to the third mode MD3. When the voltage value of the base drive signal aA is less than the threshold dvth, the level switching control circuit 716 sets the level switching control signal SIG1 to an L level and sets the level switching control signal SIG2 to an L level. Therefore, the level switching signal output circuit 710, that is, the output switching circuit 720 outputs the L-level level switching signal LS.

Thereafter, when the time elapsed from the shifting of the operation mode of the drive circuit 50 to the third mode MD3 reaches the measurement time ta1, the level switching control circuit 716 sets the level switching control signal SIG1 to an H level and sets the level switching control signal SIG2 to an L level. Therefore, the level switching signal output circuit 710, that is, the output switching circuit 720 outputs the pulse signal LSP output by the comparing circuit 714 as the level switching signal LS.

Thereafter, when the time elapsed from the shifting of the operation mode of the drive circuit 50 to the third mode MD3 reaches the measurement time tb1, the level switching control circuit 716 detects the voltage value of the base drive signal aA. The measurement time tb1 is set to be longer than the time from when the operation mode of the drive circuit 50 is shifted to the third mode MD3 to when the voltage value of the base drive signal aA becomes greater than the threshold dvth. Therefore, the voltage value of the base drive signal aA when the time elapsed from the shifting of the operation mode of the drive circuit 50 to the third mode MD3 reaches the measurement time tb1 is greater than the threshold dvth. When the detected voltage value of the base drive signal aA is greater than the threshold dvth, the level switching control circuit 716 sets the level switching control signal SIG1 to an L level and sets the level switching control signal SIG2 to an H level. Therefore, the level switching signal output circuit 710, that is, the output switching circuit 720 outputs the H-level level switching signal LS.

Thereafter, when the voltage value of the base drive signal aA reaches a predetermined voltage value, the voltage value of the base drive signal aA becomes constant and the operation mode of the drive circuit 50 is shifted from the third mode MD3 to the second mode MD2. In this case, the level switching control circuit 716 detects that the voltage value of the base drive signal aA has become constant, and thus detects a falling edge of the reference signal REF, thereby detecting that the operation mode of the drive circuit 50 has been shifted from the third mode MD3 to the second mode MD2. When the operation mode of the drive circuit 50 is shifted from the third mode MD3 to the second mode MD2, the level switching control circuit 716 sets the level switching control signal SIG1 to an L level and sets the level switching control signal SIG2 to an L level. That is, immediately after the operation mode of the drive circuit 50 is shifted from the third mode MD3 to the second mode MD2, the level switching signal output circuit 710, that is, the output switching circuit 720 outputs the L-level level switching signal LS.

In this case, the level switching control circuit 716 starts measuring time elapsed from the shifting of the operation mode of the drive circuit 50 from the third mode MD3 to the second mode MD2. Then, when the time elapsed from the shifting of the operation mode of the drive circuit 50 from the third mode MD3 to the second mode MD2 reaches the measurement time tp1, the level switching control circuit 716 sets the level switching control signal SIG1 to an L level and sets the level switching control signal SIG2 to an H level. Therefore, the level switching signal output circuit 710, that is, the output switching circuit 720 outputs the H-level level switching signal LS.

In the third mode MD3 immediately before the operation mode of the drive circuit 50 is shifted from the second mode MD2 to the first mode MD1, the voltage value of the base drive signal aA decreases. In this case, the level switching control circuit 716 detects a decrease in the voltage value of the base drive signal aA, that is, a falling edge of the reference signal REF, thereby detecting that the operation mode of the drive circuit 50 has been shifted from the second mode MD2 to the third mode MD3. Then, the level switching control circuit 716 starts measuring time elapsed from the shifting of the operation mode of the drive circuit 50 to the third mode MD3.

The level switching control circuit 716 detects the voltage value of the base drive signal aA immediately before or immediately after the operation mode of the drive circuit 50 is shifted from the second mode MD2 to the third mode MD3. In this case, the voltage value of the base drive signal aA is greater than the threshold dvth since the operation mode of the drive circuit 50 is the second mode MD2 or is immediately after the operation mode is shifted from the second mode MD2 to the third mode MD3. When the voltage value of the base drive signal aA is greater than the threshold dvth, the level switching control circuit 716 sets the level switching control signal SIG1 to an L level and sets the level switching control signal SIG2 to an H level. Therefore, the level switching signal output circuit 710, that is, the output switching circuit 720 outputs the H-level level switching signal LS.

Thereafter, when the time elapsed from the shifting of the operation mode of the drive circuit 50 to the third mode MD3 reaches the measurement time ta2, the level switching control circuit 716 sets the level switching control signal SIG1 to an H level and sets the level switching control signal SIG2 to an L level. Therefore, the level switching signal output circuit 710, that is, the output switching circuit 720 outputs the pulse signal LSP output by the comparing circuit 714 as the level switching signal LS.

Thereafter, when the time elapsed from the shifting of the operation mode of the drive circuit 50 to the third mode MD3 reaches the measurement time tb2, the level switching control circuit 716 detects the voltage value of the base drive signal aA. In this case, the measurement time tb2 is set to be longer than the time from when the operation mode of the drive circuit 50 is shifted to the third mode MD3 to when the voltage value of the base drive signal aA becomes less than the threshold dvth. Therefore, the voltage value of the base drive signal aA when the time elapsed from the shifting of the operation mode of the drive circuit 50 to the third mode MD3 reaches the measurement time tb2 is less than the threshold dvth. When the detected voltage value of the base drive signal aA is less than the threshold dvth, the level switching control circuit 716 sets the level switching control signal SIG1 to an L level and sets the level switching control signal SIG2 to an L level. Therefore, the level switching signal output circuit 710, that is, the output switching circuit 720 outputs the L-level level switching signal LS.

Thereafter, when the voltage value of the base drive signal aA reaches a predetermined voltage value, the voltage value of the base drive signal aA becomes constant and the operation mode of the drive circuit 50 is shifted from the third mode MD3 to the first mode MD1. In this case, the level switching control circuit 716 detects that the voltage value of the base drive signal aA has become constant, and thus detects a rising edge of the reference signal REF, thereby detecting that the operation mode of the drive circuit 50 has been shifted from the third mode MD3 to the first mode MD1. When the operation mode of the drive circuit 50 is shifted from the third mode MD3 to the first mode MD1, the level switching control circuit 716 sets the level switching control signal SIG1 to an L level and sets the level switching control signal SIG2 to an H level. That is, immediately after the operation mode of the drive circuit 50 is shifted from the third mode MD3 to the first mode MD1, the level switching signal output circuit 710, that is, the output switching circuit 720 outputs the H-level level switching signal LS.

In this case, the level switching control circuit 716 starts measuring time elapsed from the shifting of the operation mode of the drive circuit 50 from the third mode MD3 to the first mode MD1. When the time elapsed from the shifting of the operation mode of the drive circuit 50 from the third mode MD3 to the first mode MD1 reaches the measurement time tp2, the level switching control circuit 716 sets the level switching control signal SIG1 to an L level and sets the level switching control signal SIG2 to an L level. Therefore, the level switching signal output circuit 710, that is, the output switching circuit 720 outputs the L-level level switching signal LS.

As described above, in the third mode MD3 in a period of time when the voltage value of the signal waveform defined by the base drive signal dA changes, the level switching signal output circuit 710 switches, in accordance with the feedback signal VFB1, the electrical potential that is the logic level of the level switching signal LS.

As described above, in the third mode MD3 immediately before the operation mode of the drive circuit 50 is shifted from the first mode MD1 to the second mode MD2 or from the second mode MD2 to the first mode MD1, the level switching signal output circuit 710 has a period of time for outputting the constant L-level level switching signal LS, a period of time for outputting the pulse signal LSP as the level switching signal LS, and a period of time for outputting the constant H-level level switching signal LS.

Specifically, the level switching signal output circuit 710 switches the logic level of the level switching control signal SIG1 and the logic level of the level switching control signal SIG2 based on the timing information ST acquired from the storage circuit 718 in accordance with the waveform information signal WAV and the drive element number information signal CNT. Therefore, in the third mode MD3 in which the value of the base drive signal aA changes, in a case where the voltage value of the base drive signal aA changes to a value greater than the threshold dvth after passing through the threshold dvth and in a case where the voltage value of the base drive signal aA changes to a value less than the threshold dvth after passing through the threshold dvth, the level switching signal output circuit 710 is in a state in which the level switching signal output circuit 710 outputs the level switching signal LS that changes between an L level and an H level in accordance with the feedback signal VFB1, and is in a state in which the level switching signal output circuit 710 outputs the level switching signal LS that is constant at an L level or an H level.

In the level switching signal output circuit 710 configured as described above, the pulse signal LSP is obtained by comparing the voltage value of the feedback signal VFB1 with the voltage value of the reference signal REF, and is generated such that the voltage value of the feedback signal VFB1 follows the voltage value of the reference signal REF. Since the level switching signal LS is generated using the pulse signal LSP, even when load capacitance that is the piezoelectric elements 60 or the like to which the output drive signal COM is supplied changes in the drive circuit 50, the effect of the change in the load capacitance is reduced, and the accuracy of the waveform of the drive signal COM is improved.

In the entire period of the third mode MD3 immediately before the operation mode of the drive circuit 50 is shifted from the first mode MD1 to the second mode MD2 or from the second mode MD2 to the first mode MD1, when the level switching signal output circuit 710 outputs the level switching signal LS corresponding to the pulse signal LSP, a period of time when the switching operation in the amplifier circuit 550 and the switching operation in the level shift circuit 750 are executed in parallel may increase, and thus the power consumption of the drive circuit 50 may increase. On the other hand, in the drive circuit 50 according to the present embodiment, in the third mode MD3 immediately before the operation mode of the drive circuit 50 is shifted from the first mode MD1 to the second mode MD2 or from the second mode MD2 to the first mode MD1, the period of time for outputting the constant L-level level switching signal LS, the period of time for outputting the pulse signal LSP as the level switching signal LS, and the period of time for outputting the constant H-level level switching signal LS are included, and thus it is possible to improve the accuracy of the waveform of the drive signal COM and to reduce the possibility that power consumption in the drive circuit 50 may increase.

In the third mode MD3, the measurement time ta1, ta2, tb1, and tb2 that define the periods of time for outputting the constant L-level level switching signal LS, the periods of time for outputting the pulse signal LSP as the level switching signal LS, and the periods of time for outputting the constant H-level level switching signal LS are determined in accordance with the waveform information signal WAV and the drive element number information signal CNT, and thus are determined in accordance with the signal waveform of the drive signal COM output by the drive circuit 50 and the number of piezoelectric elements 60 to be driven by the drive signal COM. Accordingly, it is possible to use the optimum measurement time ta1, ta2, tb1, and tb2 in accordance with the operation of the liquid ejecting apparatus 1, and the accuracy of the waveform of the drive signal COM is further improved.

For example, when it is determined that the period of time when the voltage value of the base drive signal aA changes is long based on the waveform information signal WAV, timing information ST that causes the measurement time ta1 to be long and causes the measurement time ta2 to be short may be selected. As a result, a period of time when the switching operation in the amplifier circuit 550 and the switching operation in the level shift circuit 750 are executed in parallel is reduced, and the possibility that the power consumption in the drive circuit 50 may increase is further reduced. For example, in a case where it is determined that the number of piezoelectric elements 60 to which the drive signal COM output by the drive circuit 50 is supplied is large based on the drive element number information signal CNT, timing information ST that causes the measurement time ta1 to be short and causes the measurement time ta2 to be long may be selected. As a result, the periods of time for outputting the pulse signal LSP as the level switching signal LS increase, and the accuracy of the waveform of the drive signal COM output by the drive circuit 50 is further improved. For example, in a case where it is determined that the amount of change in the drive signal COM per unit time in the third mode MD3 is large based on the waveform information signal WAV, timing information ST that causes the measurement time ta1 to be short and causes the measurement time ta2 to be long may be selected. As a result, the periods of time for outputting the pulse signal LSP as the level switching signal LS increase, and the accuracy of the waveform of the drive signal COM output by the drive circuit 50 is further improved.

It is preferable that the measurement time ta1 be shorter than the time from when the operation mode is shifted to the third mode MD3 to when the voltage value of the base drive signal aA changes to a value greater than the threshold dvth after passing through the threshold dvth, the measurement time ta2 be shorter than the time from when the operation mode is shifted to the third mode MD3 to when the voltage value of the base drive signal aA changes to a value less than the threshold dvth after passing through the threshold dvth, the measurement time tb1 be longer than the time from when the operation mode is shifted to the third mode MD3 to when the voltage value of the base drive signal aA changes to a value greater than the threshold dvth after passing through the threshold dvth, and the measurement time tb2 be longer than the time from when the operation mode is shifted to the third mode MD3 to when the voltage value of the base drive signal aA changes to a value less than the threshold dvth after passing through the threshold dvth. That is, it is preferable that the level switching signal output circuit 710 output the pulse signal LSP as the level switching signal LS at the timing at which the voltage value of the base drive signal aA changes to a value greater than the threshold dvth after passing through the threshold dvth and at the timing at which the voltage value of the base drive signal aA changes to a value less than the threshold dvth after passing through the threshold dvth.

As described above, the drive circuit 50 operates in the first mode MD1 in a period of time when the voltage value of the base drive signal aA is less than the threshold dvth, and operates in the second mode MD2 in a period of time when the voltage value of the base drive signal aA is greater than the threshold dvth. Therefore, at the timing at which the voltage value of the base drive signal aA changes to a value greater than the threshold dvth after passing through the threshold dvth and at the timing at which the voltage value of the base drive signal aA changes to a value less than the threshold dvth after passing through the threshold dvth, the reference electrical potential of the first amplified modulated signal AMS1 output as the second amplified modulated signal AMS2 steeply changes. Since the level switching signal output circuit 710 outputs the level switching signal LS corresponding to the pulse signal LSP at the timing at which the operation mode is switched and at which the reference electrical potential of the first amplified modulated signal AMS1 output as the second amplified modulated signal AMS2 steeply changes, it is possible to reduce the possibility that the signal waveform of the drive signal COM may be distorted due to the switching of the operation mode of the drive circuit 50.

As described above, immediately after the operation mode of the drive circuit 50 is shifted from the third mode MD3 to the second mode MD2, the level switching signal output circuit 710 outputs the L-level level switching signal LS for the measurement time tp1 and then outputs the H-level level switching signal LS based on the timing information ST acquired from the storage circuit 718 in accordance with the waveform information signal WAV and the drive element number information signal CNT. Immediately after the operation mode of the drive circuit 50 is shifted from the third mode MD3 to the first mode MD1, the level switching signal output circuit 710 outputs the H-level level switching signal LS for the measurement time tp2 and then outputs the L-level level switching signal LS based on the timing information ST acquired from the storage circuit 718 in accordance with the waveform information signal WAV and the drive element number information signal CNT. Accordingly, when the operation mode of the drive circuit 50 is shifted from the third mode MD3 to the second mode MD2, the possibility that overshoot may be superimposed on the signal waveform of the drive signal COM is reduced, and when the operation mode of the drive circuit 50 is shifted from the third mode MD3 to the first mode MD1, the possibility that undershoot may occur in the signal waveform of the drive signal COM is reduced.

In order to describe a mechanism for the reduction according to the present embodiment, overshoot superimposed on a drive signal output by a drive circuit according to a comparative example will be described. The drive circuit according to the comparative example outputs a drive signal for driving a capacitive load such as a piezoelectric element as in the drive circuit 50 according to the present embodiment, and is different from the drive circuit 50 according to the present embodiment only in that the drive circuit according to the comparative example does not have a configuration for outputting, for a predetermined period of time, an L-level level switching signal LS when a voltage value of a signal waveform defined by a base drive signal is shifted from an increasing value to a constant value, which is similar to the characteristic configuration in the liquid ejecting apparatus 1 according to the present embodiment. That is, the drive circuit according to the comparative example outputs the drive signal for driving the capacitive load, and outputs an H-level level switching signal LS when the voltage value of the signal waveform defined by the base drive signal is shifted from an increasing value to a constant value.

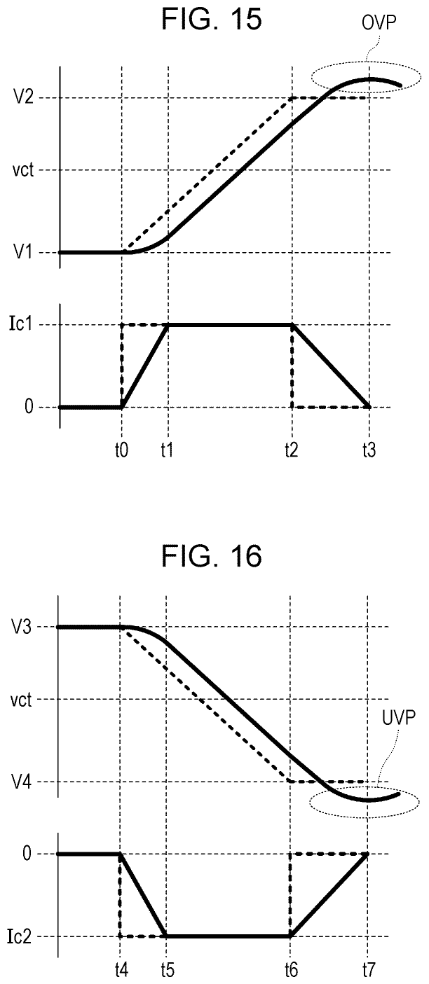

FIG. 15 is a diagram for explaining a mechanism by which overshoot occurs. FIG. 15 illustrates a case where a voltage value of a drive signal output by the drive circuit according to the comparative example increases from a voltage V1 toward a voltage V2 after passing through a threshold voltage vct at which a logic level of a level switching signal is switched. FIG. 15 illustrates the voltage value of the drive signal output by the drive circuit according to the comparative example as an output drive voltage by using a solid line, illustrates a current value of a current supplied to the capacitive load such as a piezoelectric element by the drive signal output by the drive circuit according to the comparative example as an output drive current by using a solid line, illustrates a voltage value of an ideal drive signal corresponding to the signal waveform defined by the base drive signal input to the drive circuit according to the comparative example as an ideal drive voltage by using a broken line, and illustrates an ideal current value of a current supplied to the capacitive load by the ideal drive signal as an ideal drive current by using a broken line.

As illustrated in FIG. 15, before time to when the voltage value of the signal waveform defined by the base drive signal is constant, both the output drive voltage and the ideal drive voltage are constant at the voltage V1. Therefore, before time t0, no current is not supplied to the capacitive load, and therefore both the output drive current and the ideal drive current are “0”.

At time t0, when the voltage value of the signal waveform defined by the base drive signal starts increasing, the ideal drive current starts increasing toward a current Ic1, and the ideal drive voltage starts increasing from the voltage V1 toward the voltage V2 along a slope of the signal waveform defined by the base drive signal. Thereafter, at time t2, the voltage value of the signal waveform defined by the base drive signal becomes constant, whereby the ideal drive current becomes “0”, and the ideal drive voltage becomes constant at the voltage V2 having the voltage value of the signal waveform defined by the base drive signal.

On the other hand, when the voltage value of the signal waveform defined by the base drive signal starts increasing at time t0, the output drive current starts increasing with a predetermined slope due to the effect of an inductance component of an inductor included in a demodulation circuit. Then, the output drive current reaches the current Ic1 at time t1. In this case, the output drive voltage gradually increases from the voltage V1 in accordance with a slope of the output drive current, and at time t1 when the output drive current reaches the current Ic1, the output drive voltage increases toward the voltage V2 in accordance with a slope of the signal waveform defined by the base drive signal that is approximately equal to the slope of the ideal drive voltage.

Then, when the voltage value of the signal waveform defined by the base drive signal becomes constant at time t2, the output drive current decreases with a predetermined slope due to the release of energy stored in the inductor of the demodulation circuit. Then, the output drive current becomes “0” at time t3. In this case, the logic level of the level switching signal is switched from an L level to an H level since the output drive voltage changes from the voltage V1 toward the voltage V2 after passing through the threshold voltage vct. Therefore, the difference in electrical potential between both terminals of the inductor of the demodulation circuit at time t2 is less than the difference in electrical potential between both terminals of the inductor at time to. Therefore, a slope of the output drive current from time t2 to time t3 is more gradual than the slope of the output drive current from time t0 to time t1. As a result, the amount of electrical charge supplied to the capacitive load by the output drive current between time to and time t3 is greater than the amount of electrical charge supplied to the capacitive load by the ideal drive current between time to and time t3. A voltage corresponding to the difference between the amount of electrical charge supplied to the capacitive load by the output drive current and the amount of electrical charge supplied to the capacitive load by the ideal drive current is superimposed on the output drive voltage as an overshoot voltage OVP.

As described above, the overshoot voltage OVP superimposed on the output drive voltage occurs since the slope of the output drive current from time t2 to time t3 becomes more gradual and hence the amount of electrical charge supplied to the capacitive load increases. In other words, the overshoot voltage OVP superimposed on the output drive voltage can be decreased by making steeper the slope of the output drive current from time t2 to time t3.

In the drive circuit according to the comparative example, when the output drive current is a current ioc1, the voltage value of the drive signal is a voltage vcom, a voltage value of a signal output by a boost circuit is a voltage vbt, and the inductance value of the inductor included in the demodulation circuit is Ldm, a slope of the current ioc1, which is the current value of the output drive current, from time t2 to time t3 can be expressed by the following Equation (3).

$$\frac{dioc 1}{dt} = - \frac{( vcom - vbt )}{L} \qquad ( 3 )$$

On the other hand, as compared with the drive circuit according to the comparative example, the level switching signal output circuit 710 that has the characteristic configuration according to the present embodiment outputs the H-level level switching signal LS after outputting the L-level level switching signal LS for the measurement time tp1 immediately after the operation mode of the drive circuit 50 is shifted from the third mode MD3 to the second mode MD2. Immediately after the voltage value of the signal waveform defined by the base drive signal is shifted from an increasing value to a constant value, the level switching signal output circuit 710 outputs the L-level level switching signal for a predetermined period of time, and thus a slope of an output drive current from time t2 to time t3 can be expressed by the following Equation (4). As a result, the slope of the output drive current from time t2 to time t3 can be steeper, and an overshoot voltage OVP superimposed on the output drive voltage can be decreased.

$$\frac{dioc}{dt} = - \frac{vcom}{L} \qquad ( 4 )$$

That is, in the liquid ejecting apparatus 1 according to the present embodiment, immediately after the operation mode of the drive circuit 50 is shifted from the third mode MD3 to the second mode MD2, the level switching signal output circuit 710 outputs the H-level level switching signal LS after outputting the L-level level switching signal LS for the measurement time tp1, and thus it is possible to reduce overshoot superimposed on the drive signal COM.

Next, the measurement time tp1 for which the level switching signal output circuit 710 outputs the L-level level switching signal LS immediately after the operation mode of the drive circuit 50 is shifted from the third mode MD3 to the second mode MD2 will be described.

The measurement time tp1 is ideally set to the time from when the level switching signal output circuit 710 starts outputting the L-level level switching signal LS to when a current supplied to the piezoelectric elements 60 that are capacitive loads decreases based on Equation (4) and the current value of the current becomes “0”. A case where the current value of the current supplied to the piezoelectric elements 60 becomes “0” is not limited to a case where the measured value of the current is “0”, and includes a case where the current value is in a range in which the current value can be substantially treated as “0” in a case where variations in characteristics of various elements, changes in characteristics due to the surrounding environment such as temperature and humidity, operation states of the liquid ejecting apparatus 1 and the drive circuit 50, and the like are taken into consideration. In addition, the case where the current value of the current supplied to the piezoelectric elements 60 becomes “0” is not limited to a case where the measured value and the design value are “0”, and it is sufficient that distortion or overshoot that has occurred in the signal waveform of the drive signal COM is close to “0” to the extent that the distortion or the overshoot is acceptable for the driving of the piezoelectric elements 60 or the ejection of ink in accordance with the driving of the piezoelectric elements 60.

When the operation mode of the drive circuit 50 is the third mode MD3, a current Icm1 that is the current value of the current supplied to the piezoelectric elements 60 via the capacitor 562 of the demodulation circuit 560 can be expressed by the following Equation (5), where Cload is the total capacitance of the plurality of piezoelectric elements 60 that are the capacitive loads to which the drive signal COM is supplied, Cfilter is the capacitance of the capacitor C562 of the demodulation circuit 560, vmd1 is a voltage having the voltage value of the drive signal COM in the first mode MD1 immediately before shifting to the third mode MD3, vmd2 is a voltage having the voltage value of the drive signal COM in the second mode MD2 shifted from the third mode MD3, and tr is a period of time when the operation mode is the third mode MD3 immediately before shifting to the second mode MD2 from the first mode MD1.

$$Icm 1 = ( Cload + Cfilter ) \times \frac{vmd 2 - vmd 1}{t r} \qquad ( 5 )$$

That is, the current Icm1 that is the current value of the current supplied to the piezoelectric elements 60 varies depending on the number of piezoelectric elements 60 to be driven by the drive signal COM, the voltage vmd1 having the voltage value of the drive signal COM in the first mode MD1 immediately before shifting to the third mode MD3, the voltage vmd2 having the voltage value of the drive signal COM in the second mode MD2 shifted from the third mode MD3, and the waveform information of the drive signal COM, such as the amount of change in the voltage per unit time in the third mode MD3 immediately before shifting to the second mode MD2 from the first mode MD1.

Meanwhile, as indicated by Equation (4), in a period of time when the level switching signal output circuit 710 outputs the L-level level switching signal LS immediately after the operation mode of the drive circuit 50 is shifted from the third mode MD3 to the second mode MD2, a slope of the current supplied to the piezoelectric elements 60 is constant regardless of the number of piezoelectric elements 60 to be driven by the drive signal COM and the waveform information described above.

Therefore, in a case where the measurement time tp1 is set to a constant value regardless of the number of piezoelectric elements 60 to be driven by the drive signal COM and the above-described waveform information, at the timing at which the measurement time tp1 elapses, the current value of the current supplied to the piezoelectric elements 60 that are the capacitive loads may deviate from “0”, it may not be possible to sufficiently reduce overshoot superimposed on the signal waveform of the drive signal COM, the voltage value of the drive signal COM may not sufficiently increase, and as a result, different waveform distortion may occur in the signal waveform of the drive signal COM.

Specifically, in a case where the measurement time tp1 is set to a constant value regardless of the number of piezoelectric elements 60 to be driven by the drive signal COM and the waveform information described above, the current Icm1 that is the current value of the current supplied to the piezoelectric elements 60 is small, the time until the current supplied to the piezoelectric elements 60 decreases to “0” based on Equation (4) is short, and thus the current supplied to the piezoelectric elements 60 increases in the negative direction and deviates from “0” at the timing at which the measurement time tp1 elapses, the voltage value of the drive signal COM may not sufficiently increase and the signal waveform of the drive signal COM may be distorted at the timing at which the measurement time tp1 elapses.

Meanwhile, in a case where the measurement time tp1 is set to a constant value regardless of the number of piezoelectric elements 60 to be driven by the drive signal COM and the waveform information described above, the current Icm1 that is the current value of the current supplied to the piezoelectric elements 60 is large, the time until the current supplied to the piezoelectric elements 60 decreases to “0” based on Equation (4) is long, and thus the current supplied to the piezoelectric elements 60 does not sufficiently decrease and deviates from “0” at the timing at which the measured time tp1 elapses, excessive electrical charge may be supplied to the piezoelectric elements 60, and it may not be possible to sufficiently reduce overshoot superimposed on the drive signal COM.

On the other hand, in the liquid ejecting apparatus 1 according to the present embodiment, the level switching control circuit 716 acquires the timing information ST including the measurement time tp1 from the storage circuit 718 based on the waveform information signal WAV including the waveform information of the drive signal COM, such as the voltage vmd1 having the voltage value of the drive signal COM in the first mode MD1 immediately before shifting to the third mode MD3, the voltage vmd2 having the voltage value of the drive signal COM in the second mode MD2 shifted from the third mode MD3, and the amount of change in the voltage per unit time in the third mode MD3 immediately before shifting to the second mode MD2 from the first mode MD1, and the drive element number information signal CNT including information indicating the number of piezoelectric elements 60 to be driven by the drive signal COM, whereby the length of the measurement time tp1 is defined in accordance with the number of piezoelectric elements 60 to be driven by the drive signal COM and the waveform information described above. As a result, it is possible to reduce the possibility that the waveform of the drive signal COM may be distorted, and to reduce overshoot superimposed on the drive signal COM.

That is, the level switching signal output circuit 710 switches the electrical potential of the level switching signal LS, that is, the logic level of the level switching signal LS in accordance with at least one of the waveform information signal WAV or the drive element number information signal CNT. Specifically, when the voltage value of the signal waveform defined by the base drive signals dA and aA increases and becomes constant, and the operation mode of the drive circuit 50 is shifted from the third mode MD3 to the second mode MD2, the level switching signal output circuit 710 outputs the L-level level switching signal LS for the measurement time tp1 defined in accordance with at least one of the waveform information signal WAV or the drive element number information signal CNT. In this case, the level switching signal output circuit 710 sets the measurement time tp1 to be longer when the number of piezoelectric elements 60 to be driven by the drive signal COM grasped based on the drive element number information signal CNT increases, and sets the measurement time tp1 to be shorter when the number of piezoelectric elements 60 to be driven by the drive signal COM grasped based on the drive element number information signal CNT decreases.

Next, undershoot superimposed on the drive signal output by a drive circuit according to a comparative example will be described. The drive circuit according to the comparative example outputs a drive signal for driving a capacitive load such as a piezoelectric element as in the drive circuit 50 according to the present embodiment, and is different from the drive circuit 50 according to the present embodiment only in that the drive circuit according to the comparative example does not have a configuration for outputting, for a predetermined period of time, an H-level level switching signal LS when a voltage value of a signal waveform defined by a base drive signal is shifted from a decreasing value to a constant value, which is similar to the characteristic configuration in the liquid ejecting apparatus 1 according to the present embodiment. That is, the drive circuit according to the comparative example outputs the drive signal for driving the capacitive load, and outputs an L-level level switching signal LS when the voltage value of the signal waveform defined by the base drive signal is shifted from a decreasing value to a constant state.

FIG. 16 is a diagram for explaining a mechanism by which undershoot occurs. FIG. 16 illustrates a case where the voltage value of the drive signal output by the drive circuit according to the comparative example decreases from a voltage V3 toward a voltage V4 after passing through the predetermined threshold voltage vct at which a logic level of a level switching signal is switched. FIG. 16 illustrates the voltage value of the drive signal output by the drive circuit according to the comparative example as an output drive voltage by using a solid line, illustrates a current value of a current supplied to the capacitive load such as the piezoelectric element by the drive signal output by the drive circuit according to the comparative example as a output drive current by using a solid line, illustrates a voltage value of an ideal drive signal corresponding to the signal waveform defined by the base drive signal input to the drive circuit according to the comparative example as an ideal drive voltage by using a broken line, and illustrates an ideal current value supplied to the capacitive load by the ideal drive signal as an ideal drive current by using a broken line.

As illustrated in FIG. 16, before time t4 when the voltage value of the signal waveform defined by the base drive signal is constant, both the output drive voltage and the ideal drive voltage are constant at the voltage V3. Therefore, before time t4, no current is supplied to the capacitive load, and therefore both the output drive current and the ideal drive current are “0”.

At time t4, when the voltage value of the signal waveform defined by the base drive signal starts decreasing, the ideal drive current becomes a current Ic2, and the ideal drive voltage starts decreasing from the voltage V3 toward the voltage V4 along a slope of the signal waveform defined by the base drive signal. Thereafter, at time t5, the voltage value of the signal waveform defined by the base drive signal becomes constant, whereby the ideal drive current becomes “0”, and the ideal drive voltage becomes constant at the voltage V4 having the voltage value of the signal waveform defined by the base drive signal.

Meanwhile, when the voltage value of the signal waveform defined by the base drive signal starts decreasing at time t4, the output drive current starts decreasing with a predetermined slope due to the effect of an inductance component of an inductor included in a demodulation circuit. Then, the output drive current reaches a current Ic2 at time t5. In this case, the output drive voltage gradually decreases from the voltage V3 in accordance with a slope of the output drive current. At time t4 when the output drive current reaches the current Ic2, the output drive voltage decreases toward the voltage V4 with a slope approximately equal to the slope of the signal waveform defined by the base drive signal, that is, the slope of the ideal drive voltage.

When the voltage value of the signal waveform defined by the base drive signal becomes constant at time t6, the output drive current decreases with a predetermined slope due to the release of energy stored in the inductor included in the demodulation circuit. Then, the output drive current becomes “0” at time t7. In this case, since the output drive voltage changes from the voltage V3 toward the voltage V4 after passing through the threshold voltage vct, the logic level of the level switching signal is switched from an H level to an L level. Therefore, the difference in electrical potential between both terminals of the inductor of the demodulation circuit at time t6 is less than the difference in electrical potential between both terminals of the inductor at time t4. Therefore, a slope of the drive current from time t6 to time t7 is more gradual than a slope of the output drive current from time t4 to time t5. As a result, the amount of electrical charge released from the capacitive load by the output drive current between time t4 and time t7 is greater than the amount of electrical charge released from the capacitive load by the ideal drive current between time t4 and time t7. A voltage corresponding to the difference between the amount of electrical charge released from the capacitive load by the output drive current and the amount of electrical charge released from the capacitive load by the ideal drive current is superimposed on the output drive voltage as an undershoot voltage UVP.

As described above, the undershoot voltage UVP superimposed on the output drive voltage occurs since the slope of the output drive current from time t0 to time t7 becomes more gradual and hence the amount of electrical charge released from the capacitive load increases. In other words, by making steeper the slope of the output drive current from time t6 to time t7, the undershoot voltage UVP superimposed on the output drive voltage can be reduced.

In the drive circuit according to the comparative example, when the output drive current is a current ioc2, the voltage value of the drive signal is a voltage vcom, a voltage value of a voltage signal VD1 input to an amplifier circuit is a voltage vd1, and the inductance value of the inductor included in the demodulation circuit is Ldm, the slope of the current ioc2, which is the current value of the output drive current, from time t6 to time t7 can be expressed by the following Equation (6).

$$\frac{dioc 2}{dt} = \frac{( vd 1 - vcom )}{L} \qquad ( 6 )$$

On the other hand, as compared with the drive circuit according to the comparative example, the level switching signal output circuit 710 that has the characteristic configuration according to the present embodiment outputs, for the measurement time tp2, the H-level level switching signal LS immediately after the operation mode of the drive circuit 50 is shifted from the third mode MD3 to the first mode MD1, and then outputs the L-level level switching signal LS, and the level switching signal output circuit 710 outputs the H-level level switching signal for a predetermined period of time immediately after the voltage value of the signal waveform defined by the base drive signal is shifted from an increasing value to a constant value, and thus a slope of an output drive current from time t0 to time t7 can be expressed by the following equation (7). As a result, the slope of the output drive current from time t0 to time t7 can be steeper, and an undershoot voltage UVP superimposed on the output drive voltage can be decreased. In Equation (7), the voltage value of the signal output by the boost circuit is described as a voltage vbt.

$$\frac{dioc 2}{d t} = \frac{( vd 1 + vbt - vcom )}{L} \qquad ( 7 )$$

That is, in the liquid ejecting apparatus 1 according to the present embodiment, immediately after the operation mode of the drive circuit 50 is shifted from the third mode MD3 to the first mode MD1, the level switching signal output circuit 710 outputs the L-level level switching signal LS after outputting the H-level level switching signal LS for the measurement time tp2, and thus, it is possible to reduce undershoot superimposed on the drive signal COM.

Next, the measurement time tp2 for which the level switching signal output circuit 710 outputs the H-level level switching signal LS immediately after the operation mode of the drive circuit 50 is shifted from the third mode MD3 to the first mode MD1 will be described.

Ideally, the measurement time tp2 is set to time from when the level switching signal output circuit 710 starts outputting the H-level level switching signal LS to when a current based on electrical charge released from the piezoelectric elements 60 that are the capacitive loads increases based on Equation (6) and the current value of the current becomes “0”.

When the operation mode of the drive circuit 50 is the third mode MD3, a current Icm2 that is the current value of the current supplied to the piezoelectric elements 60 via the capacitor 562 of the demodulation circuit 560 can be expressed by the following Equation (8), where Cload is the total capacitance of the plurality of piezoelectric elements 60 that are the capacitive loads to which the drive signal COM is supplied, Cfilter is the capacitance of the capacitor C562 of the demodulation circuit 560, vmd2 is a voltage having the voltage value of the drive signal COM in the second mode MD2 immediately before shifting to the third mode MD3, vmd1 is a voltage having the voltage value of the drive signal COM in the first mode MD1 shifted from the third mode MD3, and tr is a period of time when the operation mode is the third mode MD3 immediately before shifting to the first mode MD1 from the second mode MD2.

$$Icm 2 = - ( Cload + Cfilter ) \times \frac{vmd 2 - vmd 1}{t r} \qquad ( 8 )$$

That is, the current Icm2 that is the current value of the current supplied to the piezoelectric elements 60 varies depending on the number of piezoelectric elements 60 to be driven by the drive signal COM, the voltage vmd2 having the voltage value of the drive signal COM in the second mode MD2 immediately before shifting to the third mode MD3, the voltage vmd1 having the voltage value of the drive signal COM in the first mode MD1 shifted from the third mode MD3, and the waveform information of the drive signal COM, such as the amount of change in the voltage per unit time in the third mode MD3 immediately before shifting to the first mode MD1 from the second mode MD2.

Meanwhile, as indicated by Equation (7), in a period of time when the level switching signal output circuit 710 outputs the H-level level switching signal LS immediately after the operation mode of the drive circuit 50 is shifted from the third mode MD3 to the first mode MD1, a slope of the current supplied to the piezoelectric elements 60 is constant regardless of the number of piezoelectric elements 60 to be driven by the drive signal COM and the waveform information described above.

Therefore, in a case where the measurement time tp2 is set to a constant value regardless of the number of piezoelectric elements 60 to be driven by the drive signal COM and the above-described waveform information, at the timing at which the measurement time tp2 elapses, the current value of the current based on electrical charge released from the piezoelectric elements 60 that are the capacitive loads may deviate from “0”, it may not be possible to sufficiently reduce undershoot superimposed on the signal waveform of the drive signal COM, and the voltage value of the drive signal COM may not sufficiently decrease and, as a result, different waveform distortion may occur in the signal waveform of the drive signal COM.

Specifically, in a case where the measurement time tp2 is set to a constant value regardless of the number of piezoelectric elements 60 to be driven by the drive signal COM and the waveform information described above, the current Icm2 that is the current value of the current supplied to the piezoelectric elements 60 is small, the time until the current supplied to the piezoelectric elements 60 decreases to “0” based on Equation (7) is short, and thus the current supplied to the piezoelectric elements 60 increases in the positive direction and deviates from “0” at the timing at which the measurement time tp2 elapses, the voltage value of the drive signal COM may not sufficiently decrease and the signal waveform of the drive signal COM may be distorted at the timing at which the measurement time tp2 elapses.

Meanwhile, in a case where the measurement time tp2 is set to a constant value regardless of the number of piezoelectric elements 60 driven by the drive signal COM and the waveform information described above, the current Icm2 that is the current value of the current based on electrical charge released from the piezoelectric elements 60 is large, the time until the current supplied to the piezoelectric elements 60 decreases to “0” based on Equation (6) is long, and thus the current supplied to the piezoelectric element 60 does not sufficiently increase and deviates from “0” at the timing at which the measurement time tp2 elapses, excessive electrical charge may be released to the piezoelectric elements 60, and it may not be possible to sufficiently reduce undershoot superimposed on the drive signal COM.

On the other hand, in the liquid ejecting apparatus 1 according to the present embodiment, the level switching control circuit 716 acquires the timing information ST including the measurement time tp2 from the storage circuit 718 based on the waveform information signal WAV including the waveform information of the drive signal COM, such as the voltage vmd2 having the voltage value of the drive signal COM in the second mode MD2 immediately before shifting to the third mode MD3, the voltage vmd1 having the voltage value of the drive signal COM in the first mode MD1 shifted from the third mode MD3, and the amount of change in the voltage per unit time in the third mode MD3 immediately before shifting to the first mode MD1 from the second mode MD2, and the drive element number information signal CNT including information indicating the number of piezoelectric elements 60 to be driven by the drive signal COM, and thus the length of the measurement time tp2 is defined in accordance with the number of piezoelectric elements 60 to be driven by the drive signal COM and the waveform information described above. As a result, it is possible to reduce the possibility that the waveform of the drive signal COM may be distorted and to reduce undershoot superimposed on the drive signal COM.

That is, the level switching signal output circuit 710 switches the electrical potential of the level switching signal LS, that is, the logic level of the level switching signal LS in accordance with at least one of the waveform information signal WAV or the drive element number information signal CNT. Specifically, immediately after the voltage value of the signal waveform defined by the base drive signals dA and aA decreases and becomes constant, and the operation mode of the drive circuit 50 is shifted from the third mode MD3 to the first mode MD1, the level switching signal output circuit 710 outputs the H-level level switching signal LS for the measurement time tp2 defined in accordance with at least one of the waveform information signal WAV or the drive element number information signal CNT. In this case, the level switching signal output circuit 710 sets the measurement time tp2 to be long when the number of piezoelectric elements 60 to be driven by the drive signal COM grasped based on the drive element number information signal CNT increases, and sets the measurement time tp2 to be short when the number of piezoelectric elements 60 to be driven by the drive signal COM grasped based on the drive element number information signal CNT decreases.

### 5. Method of Controlling Liquid Ejecting Apparatus and Drive Circuit Included in Liquid Ejecting Apparatus

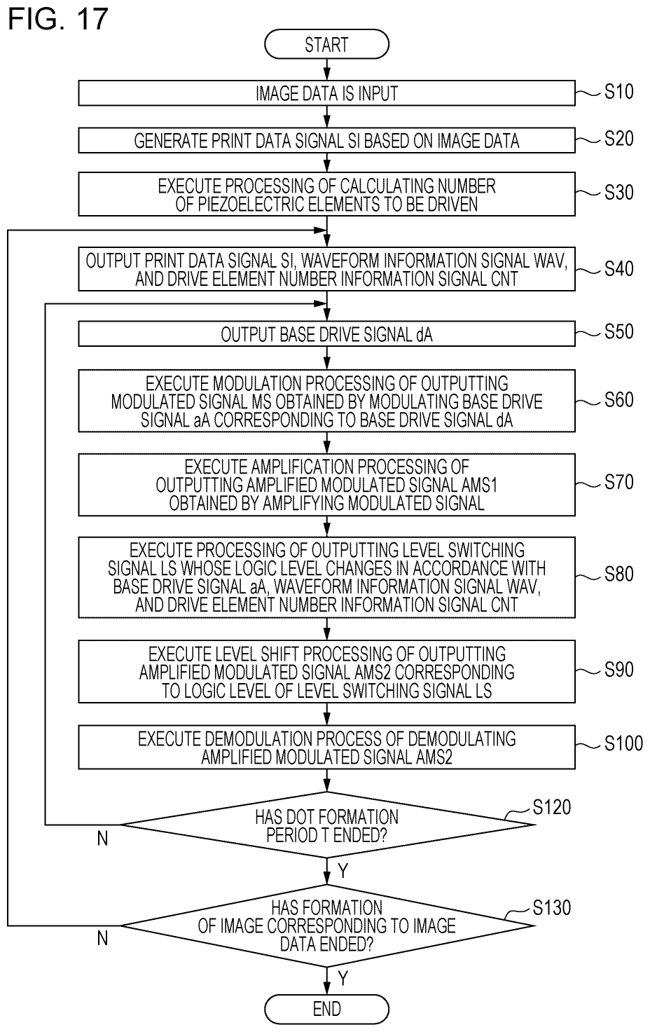

A method of controlling the liquid ejecting apparatus 1 and the drive circuit 50 included in the liquid ejecting apparatus 1 will be described. FIG. 17 is a diagram illustrating the method of controlling the liquid ejecting apparatus 1 and the drive circuit 50. As illustrated in FIG. 17, the control of the liquid ejecting apparatus 1 and the drive circuit 50 is started when the image data is input to the control circuit 100 included in the liquid ejecting apparatus 1 (step S10). Then, the control circuit 100 generates various signals including the print data signal SI by performing various types of image processing on the input image data (step S20). Thereafter, the control circuit 100 executes, based on the generated print data signal SI, processing of calculating the number of piezoelectric elements 60 to which the drive signal COM is supplied in each dot formation period T defined by the latch signal LAT (step S30).

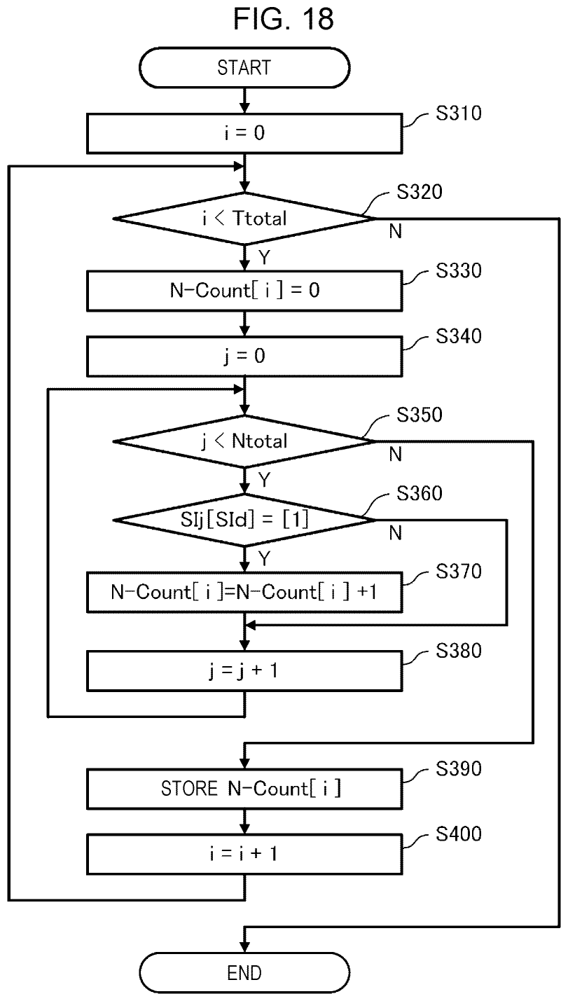

A specific example of the processing of calculating the number of piezoelectric elements to be driven in step S30 will be described. FIG. 18 is a diagram illustrating an example of the processing of calculating the number of piezoelectric elements to be driven. As illustrated in FIG. 18, when the processing of calculating the number of piezoelectric elements to be driven is executed, the control circuit 100 assign “0” to a variable i as an initial setting (step S310). Then, the control circuit 100 determines whether the variable i is less than a total dot formation period Ttotal (step S320). The total dot formation period Ttotal is a value calculated based on the image data, and is the total number of dot formation periods T required for forming the image corresponding to the image data on the medium.

If the control circuit 100 determines that the variable i is less than the total dot formation period Ttotal (Y in step S320), the control circuit 100 assigns “0” to the number N-Count[i] of nozzles for driving in the i-th dot formation period T as an initial setting (step S330), and assigns “0” to a variable j (step S340).

Thereafter, the control circuit 100 determines whether the variable j is less than the total number Ntotal of elements to be driven that is the total number of piezoelectric elements 60 to which the drive signal COM can be supplied (step S350). If the control circuit 100 determines that the variable j is less than the total number Ntotal of elements to be driven (Y in step S350), the control circuit 100 determines whether the print data SId-j is [1] (step S360). If the control circuit 100 determines that the print data SId-j is [1] (Y in step S360), the control circuit 100 adds “1” to the number N-Count[i] of nozzles for driving (step S370). That is, the control circuit 100 adds “1” to the number N-Count[i] of nozzles for driving when the drive signal COM is to be supplied to piezoelectric elements 60 included in ejection sections 600 corresponding to the print data SId-j. After 1 is added to the number N-Count[i] of nozzles for driving, or if the control circuit 100 determines that the print data SId-j is not [1] (N in step S360), the control circuit 100 adds 1 to the variable j (step S380), and repeatedly executes steps S350 to S380 described above.

That is, the control circuit 100 checks whether the print data SId corresponding to all of the piezoelectric elements 60 to which the drive signal COM can be supplied is [1] indicating that the drive signal COM is supplied, or is [0] indicating that the drive signal COM is not supplied. The control circuit 100 adds “1” to the number N-Count[i] of nozzles for driving in a case where the print data SId is [1]. As a result, the total number of piezoelectric elements 60 to be driven by the drive signal COM in the i-th dot formation period T is held in the number N-CounT[i] of nozzles for driving.

Then, if the control circuit 100 determines that the variable j is not less than the total number Ntotal of elements to be driven (N in step S350), the checking of information of the print data SId corresponding to all of the piezoelectric elements 60 to which the drive signal COM can be supplied in the i-th dot formation period T ends. In this case, the control circuit 100 stores the number N-Count[i] of nozzles for driving in a storage circuit (not illustrated) (step S390). Thus, the number of piezoelectric elements 60 to which the drive signal COM is supplied in the i-th dot formation period T is stored as the number N-Count[i] of nozzles for driving.

Thereafter, the control circuit 100 adds “1” to the variable i (step S400), and repeatedly executes steps S320 to S400 described above. That is, the control circuit 100 calculates the total number of piezoelectric elements 60 to be driven by the drive signal COM corresponding to each of all of the dot formation periods T required for forming the image corresponding to the image data on the medium, and stores the total number as the number N-counT[i] of nozzles for driving corresponding to each of the dot formation periods T. If the control circuit 100 determines that the variable i is not less than the total dot formation period Ttotal (N in step S320), the control circuit 100 determines that the calculation of the total number of piezoelectric elements 60 to be driven by the drive signals COM corresponding to all of the dot formation periods T required for forming the image corresponding to the image data on the medium has been completed, and ends the processing of calculating the number of piezoelectric elements to be driven.

As described above, the control circuit 100 calculates the number of piezoelectric elements 60 to be driven by the drive signal COM in the dot formation period T based on the print data signal SI for switching whether to supply the drive signal COM to the plurality of piezoelectric elements 60.

Returning to FIG. 17, when the processing of calculating the number of piezoelectric elements to be driven ends, the control circuit 100 outputs the print data signal SI generated based on the image data to the drive signal selection circuit 200, and outputs, to the drive circuit 50, the waveform information signal WAV including the waveform information of the drive signal COM output by the drive circuit 50 and the drive element number information signal CNT including the number N-Count[i] of nozzles for driving calculated in the processing of calculating the number of piezoelectric elements to be driven (step S40). Thereafter, the control circuit 100 outputs the base drive signal dA defining the signal waveform of the drive signal COM to the drive circuit 50 (step S50). The base drive signal dA output by the control circuit 100 is converted into the base drive signal aA by the D/A conversion circuit 510, and then input to the modulation circuit 520. The modulation circuit 520 executes modulation processing of generating the modulated signal MS by modulating the base drive signal aA corresponding to the input base drive signal dA, and outputting the generated modulated signal MS to the amplifier circuit 550 (step S60). Then, the amplifier circuit 550 executes amplification processing of amplifying the modulated signal MS based on the voltage signal VD1 to generate the first amplified modulated signal AMS1 by amplifying the modulated signal MS, and outputting the first amplified modulated signal AMS1 to the level shift circuit 750 (step S70).

The basic drive signal aA obtained by the D/A conversion circuit 510 converting the basic drive signal dA output by the control circuit 100, the waveform information signal WAV output by the control circuit 100 and including the waveform information of the drive signal COM output by the drive circuit 50, and the drive element number information signal CNT including the number N-Count[i] of nozzles for driving calculated in the processing of calculating the number of piezoelectric elements to be driven are input to the level switching signal output circuit 710. The feedback signal VFB1 corresponding to the drive signal COM is output by the feedback circuit 570 and input to the level switching signal output circuit 710. The level switching signal output circuit 710 executes processing of outputting, to the level shift circuit 750, the level switching signal LS that changes between an H level and an L level in accordance with the base drive signal aA, the waveform information signal WAV, the drive element number information signal CNT, and the feedback signal VFB1 (step S80).

That is, the level switching signal output circuit 710 switches the logic level of the level switching signal LS in accordance with the feedback signal VFB1 in a period of time when the voltage value of the signal waveform defined by the base drive signals dA and aA changes. When the voltage value of the signal waveform defined by the base drive signals dA and aA increases and becomes constant, and the operation mode of the drive circuit 50 is shifted from the third mode MD3 to the second mode MD2, the level switching signal output circuit 710 outputs the L-level level switching signal LS for the measurement time tp1 defined in accordance with at least one of the waveform information signal WAV or the drive element number information signal CNT. When the voltage value of the signal waveform defined by the base drive signals dA and aA decreases and becomes constant, and the operation mode of the drive circuit 50 is shifted from the third mode MD3 to the first mode MD1, the level switching signal output circuit 710 outputs the H-level level switching signal LS for the measurement time tp2 defined in accordance with at least one of the waveform information signal WAV or the drive element number information signal CNT. The processing of outputting the level switching signal may be executed before the modulation processing in step S60 and the amplification processing in step S70, or may be executed in parallel with the modulation processing in step S60 and the amplification processing in step S70.

After the modulation processing in step S60, the amplification processing in step S70, and the processing of outputting the level switching signal in step S80 are completed, the level shift circuit 750 executes level shift processing of generating the second amplified modulated signal AMS2 in accordance with the logic level of the input level switching signal LS and outputting the second amplified modulated signal to the demodulation circuit 560 (step S90), and the demodulation circuit 560 executes demodulation processing of demodulating the input second amplified modulated signal AMS2 (step S100). Then, the demodulation circuit 560 outputs, as the drive signal COM, a signal obtained by demodulating the second amplified modulated signal AMS2 in the demodulation processing. That is, the level shift circuit 750 outputs the signal obtained by shifting the reference electrical potential of the first amplified modulated signal AMS1 as the second amplified modulated signal AMS2 when the level switching signal LS is at an H level, and outputs the first amplified modulated signal AMS1 as the second amplified modulated signal AMS2 when the level switching signal LS is at an L level, and the demodulation circuit 560 demodulates the second amplified modulated signal AMS2 and outputs the demodulated signal as the drive signal COM.

Thereafter, the control circuit 100 determines whether the dot formation period T has ended (step S110). If the control circuit 100 determines that the dot formation period T has not ended (N in Step S110), the control circuit 100 repeatedly executes steps S50 to S110 described above. Thus, the drive circuit 50 generates and outputs the drive signal COM as illustrated in FIG. 5 in the dot formation period T.

On the other hand, if the control circuit 100 determines that the dot formation period T has ended (Y in step S110), the control circuit 100 determines whether the formation of the image corresponding to the image data has ended (step S130). Then, if the control circuit 100 determines that the formation of the image corresponding to the image data has not ended (N in step S130), steps S40 to S120 corresponding to the next dot formation period T are executed. On the other hand, if the control circuit 100 determines that the formation of the image corresponding to the image data has ended (Y in step S130), the liquid ejecting apparatus 1 and the drive circuit 50 stop the operation. As a result, the control of the liquid ejecting apparatus 1 and the drive circuit 50 included in the liquid ejecting apparatus 1 ends.

The plurality of piezoelectric elements 60 are an example of a plurality of capacitive loads, the drive circuit 50 is an example of a capacitive load drive circuit, the base drive signal aA corresponding to the base drive signal dA is an example of a base drive signal, the H level is an example of a first electrical potential, the L level is an example of a second electrical potential, the measurement time tp1 is an example of a first period of time, the measurement time tp2 is an example of a second period of time, the gate drive signal HGD2 is an example of a first gate signal, the gate drive signal LGD2 is an example of a second gate signal, the gate drive circuit 730 is an example of a gate driver, the transistor M3 is an example of a first transistor, the transistor M4 is an example of a second transistor, the voltage signal VD2 is an example of a level shift voltage signal, the voltage signal VBST is an example of a bootstrap voltage signal, the boost circuit BS is an example of a bootstrap circuit, and the second output point OP2 is an example of a coupling point. Step S40 is an example of outputting a waveform information signal and a drive element number information signal, step S60 is an example of outputting a modulated signal, step S70 is an example of outputting a first amplified modulated signal, step S80 is an example of outputting a level switching signal, step S90 is an example of outputting, as a second amplified modulated signal, a signal obtained by shifting a reference electrical potential of the first amplified modulated signal when the level switching signal is at the first electrical potential, and outputting the first amplified modulated signal as the second amplified modulated signal when the level switching signal is at the second electrical potential, and step S100 is an example of demodulating the second amplified modulated signal and outputting the drive signal.

### 6. Operational Effects

In the liquid ejecting apparatus 1, since the number of piezoelectric elements 60 driven by the drive signal COM is greatly changed, the load capacitance to which the drive signal COM output by the drive circuit 50 is supplied is greatly changed, and as a result, the accuracy of the waveform of the signal waveform of the drive signal COM may be reduced.

To address this issue, each of the liquid ejecting apparatus 1 and the drive circuit 50 according to the present embodiment includes the modulation circuit 520 that outputs the modulated signal MS obtained by modulating the base drive signal aA on which the drive signal COM is based, the amplifier circuit 550 that outputs the first amplified modulated signal AMS1 obtained by amplifying the modulated signal MS, the level switching signal output circuit 710 that outputs the level switching signal LS that changes between an H level and an L level, the level shift circuit 750 that outputs, as the second amplified modulated signal AMS2, the signal obtained by shifting the reference electrical potential of the first amplified modulated signal AMS1 when the level switching signal LS is at an H level, and that outputs the first amplified modulated signal AMS1 as the second amplified modulated signal AMS2 when the level switching signal LS is at an L level, and the demodulation circuit 560 that demodulates the second amplified modulated signal AMS2 and outputs the drive signal COM. The level switching signal output circuit 710 switches the electrical potential of the level switching signal LS in accordance with at least one of the waveform information signal WAV including the waveform information of the drive signal COM or the drive element number information signal CNT including information indicating the number of piezoelectric elements 60 to be driven by the drive signal COM, and thus can grasp, by feed forward control, the number of piezoelectric elements 60 to be driven by the drive signal COM, that is, the load capacitance to which the drive signal COM is supplied. Thus, it is possible to reduce the possibility that the accuracy of the waveform of the signal waveform of the drive signal COM output by the drive circuit 50 may be reduced due to a change in the load capacitance. That is, it is possible to improve the accuracy of the waveform of the drive signal COM output by the drive circuit 50.

Each of the method of controlling the liquid ejecting apparatus 1 according to the present embodiment and the method of controlling the drive circuit 50 includes outputting the waveform information signal WAV including the waveform information of the drive signal COM and the drive element number information signal CNT including the information indicating the number of piezoelectric elements 60 to be driven by the drive signal COM; outputting the modulated signal MS obtained by modulating the base drive signal aA on which the drive signal COM is based; outputting the first amplified modulated signal AMS1 obtained by amplifying the modulated signal MS; outputting the level switching signal LS that changes between an H level and an L level; outputting, as the second amplified modulated signal AMS2, the signal obtained by shifting the reference electrical potential of the first amplified modulated signal AMS1 when the level switching signal LS is at an H level, and outputting the first amplified modulated signal AMS1 as the second amplified modulated signal AMS2 when the level switching signal LS is at an L level; and demodulating the second amplified modulated signal AMS2 and outputting the drive signal COM. In the outputting the level switching signal LS that changes between an H level and an L level, the electrical potential of the level switching signal LS is switched in accordance with at least one of the waveform information signal WAV or the drive element number information signal CNT, and thus the number of piezoelectric elements 60 to be driven by the drive signal COM, that is, the load capacitance to which the drive signal COM is supplied can be grasped by feed forward control. Thus, it is possible to reduce the possibility that the accuracy of the waveform of the signal waveform of the drive signal COM output by the drive circuit 50 may be reduced due to a change in the load capacitance. That is, it is possible to improve the accuracy of the waveform of the drive signal COM output by the drive circuit 50.

### 7. Modifications

In the liquid ejecting apparatus 1 and the drive circuit 50 described above, in a period of time when the value of the base drive signal aA changes and the operation mode of the drive circuit 50 is the third mode MD3, the level switching signal output circuit 710 switches the logic level of the level switching signal LS in accordance with the feedback signal VFB1 output by the feedback circuit 570. However, in a period of time when the voltage value of the signal waveform defined by the base drive signal aA increases and the operation mode of the drive circuit 50 is the third mode MD3 immediately before the operation mode of the drive circuit 50 is shifted to the second mode MD2 from the first mode MD1, regardless of the feedback signal VFB1, the level switching signal output circuit 710 may set a total period of time when the level switching signal LS is at an H level in a case where the number of piezoelectric elements 60 to be driven by the drive signal COM is p1 (p1 is any natural number) to be longer than a total period of time when the level switching signal LS is at an H level in a case where the number of piezoelectric elements 60 to be driven by the drive signal COM is p2 that is less than p1. Accordingly, even in a case where the number of piezoelectric elements 60 to which the drive signal COM output by the drive circuit 50 is supplied is large, it is possible to supply a sufficient current to the piezoelectric elements 60, and the accuracy of the waveform of the drive signal COM is improved.

In a period of time when the voltage value of the signal waveform defined by the base drive signal aA decreases and the operation mode of the drive circuit 50 is the third mode MD3 immediately before the operation mode of the drive circuit 50 is shifted to the first mode MD1 from the second mode MD2, regardless of the feedback signal VFB1, the level switching signal output circuit 710 may set a total period of time when the level switching signal LS is at an L level in a case where the number of piezoelectric elements 60 to be driven by the drive signal COM is q1 (q1 is any natural number) to be longer than a total period of time when the level switching signal LS is at an L level in a case where the number of piezoelectric elements 60 to be driven by the drive signal COM is q2 that is less than q1. Accordingly, even in a case where the number of piezoelectric elements 60 to which the drive signal COM output by the drive circuit 50 is supplied is large, it is possible to draw a sufficient current from the piezoelectric elements 60, and the accuracy of the waveform of the drive signal COM is improved.

In the liquid ejecting apparatus 1 and the drive circuit 50 described above, the level switching signal output circuit 710 may switch the electrical potential of the level switching signal LS to be output, in accordance with the difference in electrical potential between the first end and the second end of the capacitor C13 included in the boost circuit BS. As indicated by Equation (7) described above, when the H-level level switching signal LS is output for the measurement time tp2 immediately after the operation mode of the drive circuit 50 is shifted from the third mode MD3 to the first mode MD1, a slope of a current based on electrical charge released from the piezoelectric elements 60 also contributes to the voltage value of the voltage signal VBST output by the boost circuit BS, that is, the difference in electrical potential between both ends of the capacitor C13 included in the boost circuit BS. Since the level switching signal output circuit 710 switches the electrical potential of the level switching signal LS to be output, in accordance with the difference in electrical potential between the first end and the second end of the capacitor C13 included in the boost circuit BS, it is possible to more appropriately set the measurement time tp2, and to further reduce the possibility that undershoot may occur in the drive signal COM to be output.

The capacitor C13 is an example of a bootstrap capacitor.

Although the embodiments have been described above, the present disclosure is not limited to these embodiments, and can be implemented in various aspects without departing from the scope of the present disclosure. For example, the above-described embodiments may be appropriately combined.

The present disclosure includes configurations that are substantially the same as the configurations described in the embodiments, for example, a configuration having the same functions, methods, and results as those described in the embodiments, or a configuration having the same purposes and effects as those described in the embodiments. The present disclosure includes configurations in which non-essential portions of the configurations described in the embodiments are replaced. The present disclosure includes configurations that achieve the same operational effects as those of the configurations described in the embodiments or configurations that can achieve the same objects as those of the configurations described in the embodiments. The present disclosure includes configurations in which a known technology is added to the configurations described in the embodiments.

The following contents are derived from the above-described embodiments.

According to a first aspect, there is provided a liquid ejecting apparatus including: an ejection head that includes a plurality of capacitive loads that are driven when a drive signal is supplied to the plurality of capacitive loads, and that ejects liquid by driving the plurality of capacitive loads; a capacitive load drive circuit that outputs the drive signal; and a control circuit that controls the ejection head and the capacitive load drive circuit, wherein the capacitive load drive circuit includes a modulation circuit that outputs a modulated signal obtained by modulating a base drive signal on which the drive signal is based, an amplifier circuit that outputs a first amplified modulated signal obtained by amplifying the modulated signal, a level switching signal output circuit that outputs a level switching signal that changes between a first electrical potential and a second electrical potential, a level shift circuit that outputs, as a second amplified modulated signal, a signal obtained by shifting a reference electrical potential of the first amplified modulated signal when the level switching signal is at the first electrical potential, and that outputs the first amplified modulated signal as the second amplified modulated signal when the level switching signal is at the second electrical potential, and a demodulation circuit that demodulates the second amplified modulated signal and outputs the drive signal, the control circuit outputs a waveform information signal including waveform information of the drive signal, and a drive element number information signal including information indicating the number of elements that are among the plurality of capacitive loads and are to be driven by the drive signal, and the level switching signal output circuit switches an electrical potential of the level switching signal in accordance with at least one of the waveform information signal or the drive element number information signal.

In the liquid ejecting apparatus, the level switching signal output circuit switches the electrical potential of the level switching signal in accordance with at least one of the waveform information signal including the waveform information of the drive signal or the drive element number information signal including the information indicating the number of elements that are among the plurality of capacitive loads and are to be driven by the drive signal, the level shift circuit outputs, as the second amplified modulated signal, the signal obtained by shifting the reference electrical potential of the first amplified modulated signal when the level switching signal is at the first electrical potential, outputs the first amplified modulated signal as the second amplified modulated signal when the level switching signal is at the second electrical potential, and thus executes feed forward control in accordance with the number of elements that are among the plurality of capacitive loads and are to be driven by the drive signal. Thus, even when the load capacitance to which the drive signal is supplied is changed, the accuracy of the waveform of the drive signal can be improved. That is, the accuracy of the waveform of the drive signal output can be improved.

According to a second aspect, in the liquid ejecting apparatus according to the first aspect, the control circuit may generate the drive element number information signal based on a switching control signal for switching whether to supply the drive signal to the plurality of capacitive loads, and may output the drive element number information signal to the level switching signal output circuit.

According to a third aspect, in the liquid ejecting apparatus according to the second aspect, the control circuit may output the drive element number information signal in each dot formation period in which a dot is formed on a medium by the liquid ejected from the ejection head.

In the liquid ejecting apparatus, even when the load capacitance to which the drive signal is supplied is changed in each dot formation period, it is possible to increase the accuracy of the waveform of the drive signal. That is, the accuracy of the waveform of the drive signal output can be improved.

According to a fourth aspect, in the liquid ejecting apparatus according to the first aspect, when a voltage value of a signal waveform defined by the base drive signal increases and becomes constant, the level switching signal output circuit may output the level switching signal at the first electrical potential for a first period of time defined in accordance with at least one of the waveform information signal or the drive element number information signal.

In the liquid ejecting apparatus, it is possible to reduce the possibility that overshoot may be superimposed on the drive signal, and the accuracy of the waveform of the drive signal is further improved.

According to a fifth aspect, in the liquid ejecting apparatus according to the first aspect, when a voltage value of a signal waveform defined by the base drive signal decreases and becomes constant, the level switching signal output circuit may output the level switching signal at the second electrical potential for a second period of time defined in accordance with at least one of the waveform information signal or the drive element number information signal.

In the liquid ejecting apparatus, it is possible to reduce the possibility that undershoot may be superimposed on the drive signal, and the accuracy of the waveform of the drive signal is further improved.

According to a sixth aspect, in the liquid ejecting apparatus according to the first aspect, in a period of time when a voltage value of a signal waveform defined by the base drive signal increases, a total period of time when the level switching signal output circuit outputs the level switching signal at the first electrical potential in a case where the number of elements to be driven is p1 may be longer than a total period of time when the level switching signal output circuit outputs the level switching signal at the first electrical potential in a case where the number of elements to be driven is p2 that is less than p1.

In the liquid ejecting apparatus, the followability of the signal waveform defined by the base drive signal by the drive signal is improved, and the accuracy of the waveform of the drive signal is further improved.

According to a seventh aspect, in the liquid ejecting apparatus according to the first aspect, in a period of time when a voltage value of a signal waveform defined by the base drive signal decreases, a total period of time when the level switching signal output circuit outputs the level switching signal at the second electrical potential in a case where the number of elements to be driven is q1 may be longer than a total period of time when the level switching signal output circuit outputs the level switching signal at the second electrical potential in a case where the number of elements to be driven is q2 that is less than q1.

In the liquid ejecting apparatus, the followability of the signal waveform defined by the base drive signal by the drive signal is improved, and the accuracy of the waveform of the drive signal is further improved.

According to an eighth aspect, the liquid ejecting apparatus according to the first aspect may further include a feedback circuit that outputs a feedback signal corresponding to the drive signal, wherein the level switching signal output circuit may switch the electrical potential of the level switching signal in accordance with the feedback signal in a period of time when a voltage value of a signal waveform defined by the drive signal changes.

In the liquid ejecting apparatus, the followability of the signal waveform defined by the base drive signal by the drive signal is improved, and the accuracy of the waveform of the drive signal is further improved.

According to a ninth aspect, in the liquid ejecting apparatus according to any one of the first to eighth aspects, the level shift circuit may include a gate driver that outputs a first gate signal and a second gate signal in accordance with the level switching signal, a first transistor in which a conduction state between a drain terminal and a source terminal is controlled in accordance with the first gate signal, a second transistor in which a conduction state between a drain terminal and a source terminal is controlled in accordance with the second gate signal, and a bootstrap circuit to which the first amplified modulated signal and a level shift voltage signal are input, and that outputs a bootstrap voltage signal obtained by shifting the reference electrical potential of the first amplified modulated signal in accordance with the level shift voltage signal. The bootstrap voltage signal may be input to the drain terminal of the first transistor, and the first amplified modulated signal may be input to the source terminal of the second transistor. The source terminal of the first transistor and the drain terminal of the second transistor may be electrically coupled at a coupling point. When the level switching signal is at the first electrical potential, the gate driver may output the first gate signal for controlling the first transistor to be conductive between the drain terminal and the source terminal of the first transistor. When the level switching signal is at the second electrical potential, the gate driver may output the second gate signal for controlling the second transistor to be conductive between the drain terminal and the source terminal of the second transistor. The level shift circuit may output a signal at the coupling point as the second amplified modulated signal.

According to a tenth aspect, in the liquid ejecting apparatus according to the ninth aspect, the bootstrap circuit may include a bootstrap capacitor having a first end electrically coupled to the drain terminal of the first transistor, and a second end electrically coupled to the coupling point, and the level switching signal output circuit may switch the electrical potential of the level switching signal to be output, in accordance with a difference in electrical potential between the first end and the second end of the bootstrap capacitor.

In the liquid ejecting apparatus, it is possible to reduce the possibility that undershoot may be superimposed on the drive signal, and the accuracy of the waveform of the drive signal is further improved.

According to an eleventh aspect, there is provided a method of controlling a liquid ejecting apparatus including an ejection head that includes a plurality of capacitive loads that are driven when a drive signal is supplied to the plurality of capacitive loads, and that ejects liquid by driving the plurality of capacitive loads, a capacitive load drive circuit that outputs the drive signal, and a control circuit that controls the ejection head and the capacitive load drive circuit, the method including: outputting a waveform information signal including waveform information of the drive signal, and a drive element number information signal including information indicating the number of elements that are among the plurality of capacitive loads and are to be driven by the drive signal; outputting a modulated signal obtained by modulating a base drive signal on which the drive signal is based; outputting a first amplified modulated signal obtained by amplifying the modulated signal; outputting a level switching signal that changes between a first electrical potential and a second electrical potential; outputting, as a second amplified modulated signal, a signal obtained by shifting a reference electrical potential of the first amplified modulated signal when the level switching signal is at the first electrical potential, and outputting the first amplified modulated signal as the second amplified modulated signal when the level switching signal is at the second electrical potential; and demodulating the second amplified modulated signal and outputting the drive signal, wherein in the outputting the level switching signal, an electrical potential of the level switching signal is switched in accordance with at least one of the waveform information signal or the drive element number information signal.

In the method of controlling the liquid ejecting apparatus, in the outputting the level switching signal, the electrical potential of the level switching signal is switched in accordance with at least one of the waveform information signal including the waveform information of the drive signal or the drive element number information signal including the information indicating the number of elements that are among the plurality of capacitive loads and are to be driven by the drive signal, and in the outputting the second amplified modulated signal, the signal obtained by shifting the reference electrical potential of the first amplified modulated signal is output as the second amplified modulated signal when the level switching signal is at the first electrical potential, and the first amplified modulated signal is output as the second amplified modulated signal when the level switching signal is at the second electrical potential. Therefore, the feed forward control is executed in accordance with the number of elements that are among the plurality of capacitive loads and are to be driven by the drive signal. Thus, even when the load capacitance to which the drive signal is supplied is changed, the accuracy of the waveform of the drive signal can be improved. That is, the accuracy of the waveform of the drive signal output can be improved.

According to a twelfth aspect, in the method of controlling the liquid ejecting apparatus according to the eleventh aspect, the drive element number information signal may be generated based on a switching control signal for switching whether to supply the drive signal to the plurality of capacitive loads.

According to a thirteenth aspect, in the method of controlling the liquid ejecting apparatus according to the twelfth aspect, the drive element number information signal may be output in each dot formation period in which a dot is formed on a medium by the liquid ejected from the ejection head.

In the method of controlling the liquid ejecting apparatus, even when the load capacitance to which the drive signal is supplied is changed in each dot formation period, it is possible to increase the accuracy of the waveform of the drive signal. That is, the accuracy of the waveform of the drive signal output can be improved.

According to a fourteenth aspect, in the method of controlling the liquid ejecting apparatus according to the eleventh aspect, in the outputting the level switching signal, when a voltage value of a signal waveform defined by the base drive signal increases and becomes constant, the level switching signal at the first electrical potential may be output for a first period of time defined in accordance with at least one of the waveform information signal or the drive element number information signal.

In the method of controlling the liquid ejecting apparatus, it is possible to reduce the possibility that overshoot may be superimposed on the drive signal, and the accuracy of the waveform of the drive signal is further improved.

According to a fifteenth aspect, in the method of controlling the liquid ejecting apparatus according to the eleventh aspect, in the outputting the level switching signal, when a voltage value of a signal waveform defined by the base drive signal decreases and becomes constant, the level switching signal at the second electrical potential may be output for a second period of time defined in accordance with at least one of the waveform information signal or the drive element number information signal.

In the method of controlling the liquid ejecting apparatus, it is possible to reduce the possibility that undershoot may be superimposed on the drive signal, and the accuracy of the waveform of the drive signal is further improved.

According to a sixteenth aspect, in the method of controlling the liquid ejecting apparatus according to the eleventh aspect, in the outputting the level switching signal, in a period of time when a voltage value of a signal waveform defined by the base drive signal increases, a total period of time when the level switching signal at the first electrical potential is output may be longer in a case where the number of elements to be driven is p1 than in a case where the number of elements to be driven is p2 that is less than p1.

In the method of controlling the liquid ejecting apparatus, the followability of the signal waveform defined by the base drive signal by the drive signal is improved, and the accuracy of the waveform of the drive signal is further improved.

According to a seventeenth aspect, in the method of controlling the liquid ejecting apparatus according to the eleventh aspect, in the outputting the level switching signal, in a period of time when a voltage value of a signal waveform defined by the base drive signal decreases, a total period of time when the level switching signal at the second electrical potential is output may be longer in a case where the number of elements to be driven is q1 than in a case where the number of elements to be driven is q2 that is less than q1.

In the method of controlling the liquid ejecting apparatus, the followability of the signal waveform defined by the base drive signal by the drive signal is improved, and the accuracy of the waveform of the drive signal is further improved.

According to an eighteenth aspect, in the method of controlling the liquid ejecting apparatus according to the eleventh aspect, in the outputting the level switching signal, in a period of time when a voltage value of a signal waveform defined by the base drive signal changes, the electrical potential of the level switching signal may be switched in accordance with a feedback signal corresponding to the drive signal.

In the method of controlling the liquid ejecting apparatus, the followability of the signal waveform defined by the base drive signal by the drive signal is improved, and the accuracy of the waveform of the drive signal is further improved.

According to a nineteenth aspect, in the method of controlling the liquid ejecting apparatus according to any one of the eleventh to eighteenth aspects, the capacitive load drive circuit may include a gate driver that outputs a first gate signal and a second gate signal in accordance with the level switching signal, a first transistor in which a conduction state between a drain terminal and a source terminal is controlled in accordance with the first gate signal, a second transistor in which a conduction state between a drain terminal and a source terminal is controlled in accordance with the second gate signal, and a bootstrap circuit to which the first amplified modulated signal and a level shift voltage signal are input, and that outputs a bootstrap voltage signal obtained by shifting the reference electrical potential of the first amplified modulated signal in accordance with the level shift voltage signal, the bootstrap voltage signal may be input to the drain terminal of the first transistor, the first amplified modulated signal may be input to the source terminal of the second transistor, the source terminal of the first transistor and the drain terminal of the second transistor may be electrically coupled at a coupling point, the gate driver may output the first gate signal for controlling the first transistor to be conductive between the drain terminal and the source terminal of the first transistor when the level switching signal is at the first electrical potential, and output the second gate signal for controlling the second transistor to be conductive between the drain terminal and the source terminal of the second transistor when the level switching signal is at the second electrical potential, and the gate driver may output a signal at the coupling point as the second amplified modulated signal.

According to a twentieth aspect, in the method of controlling the liquid ejecting apparatus according to the nineteenth aspect, the bootstrap circuit may include a bootstrap capacitor having a first end electrically coupled to the drain terminal of the first transistor, and a second end electrically coupled to the coupling point, and in the outputting the level switching signal, the electrical potential of the level switching signal to be output may be switched in accordance with a difference in electrical potential between the first end and the second end of the bootstrap capacitor.

In the method of controlling the liquid ejecting apparatus, it is possible to reduce the possibility that undershoot may be superimposed on the drive signal, and the accuracy of the waveform of the drive signal is further improved.

What is claimed is:

1. A liquid ejecting apparatus comprising:
an ejection head that includes a plurality of capacitive loads that are driven when a drive signal is supplied to the plurality of capacitive loads, and that ejects liquid by driving the plurality of capacitive loads;
a capacitive load drive circuit that outputs the drive signal; and
a control circuit that controls the ejection head and the capacitive load drive circuit, wherein
the capacitive load drive circuit includes
a modulation circuit that outputs a modulated signal obtained by modulating a base drive signal on which the drive signal is based,
an amplifier circuit that outputs a first amplified modulated signal obtained by amplifying the modulated signal,
a level switching signal output circuit that outputs a level switching signal that changes between a first electrical potential and a second electrical potential,
a level shift circuit that outputs, as a second amplified modulated signal, a signal obtained by shifting a reference electrical potential of the first amplified modulated signal when the level switching signal is at the first electrical potential, and that outputs the first amplified modulated signal as the second amplified modulated signal when the level switching signal is at the second electrical potential, and
a demodulation circuit that demodulates the second amplified modulated signal and outputs the drive signal,
the control circuit outputs a waveform information signal including waveform information of the drive signal, and a drive element number information signal including information indicating a number of elements that are among the plurality of capacitive loads and are to be driven by the drive signal, and
the level switching signal output circuit switches an electrical potential of the level switching signal in accordance with at least one of the waveform information signal or the drive element number information signal.

2. The liquid ejecting apparatus according to claim 1, wherein
the control circuit generates the drive element number information signal based on a switching control signal for switching whether to supply the drive signal to the plurality of capacitive loads, and outputs the drive element number information signal to the level switching signal output circuit.

3. The liquid ejecting apparatus according to claim 2, wherein
the control circuit outputs the drive element number information signal in each dot formation period in which a dot is formed on a medium by the liquid ejected from the ejection head.

4. The liquid ejecting apparatus according to claim 1, wherein
when a voltage value of a signal waveform defined by the base drive signal increases and becomes constant, the level switching signal output circuit outputs the level switching signal at the first electrical potential for a first period of time defined in accordance with at least one of the waveform information signal or the drive element number information signal.

5. The liquid ejecting apparatus according to claim 1, wherein
when a voltage value of a signal waveform defined by the base drive signal decreases and becomes constant, the level switching signal output circuit outputs the level switching signal at the second electrical potential for a second period of time defined in accordance with at least one of the waveform information signal or the drive element number information signal.

6. The liquid ejecting apparatus according to claim 1, wherein
in a period of time when a voltage value of a signal waveform defined by the base drive signal increases, a total period of time when the level switching signal output circuit outputs the level switching signal at the first electrical potential in a case where the number of elements to be driven is p1 is longer than a total period of time when the level switching signal output circuit outputs the level switching signal at the first electrical potential in a case where the number of elements to be driven is p2 that is less than p1.

7. The liquid ejecting apparatus according to claim 1, wherein
in a period of time when a voltage value of a signal waveform defined by the base drive signal decreases, a total period of time when the level switching signal output circuit outputs the level switching signal at the second electrical potential in a case where the number of elements to be driven is q1 is longer than a total period of time when the level switching signal output circuit outputs the level switching signal at the second electrical potential in a case where the number of elements to be driven is q2 that is less than q1.

8. The liquid ejecting apparatus according to claim 1, further comprising:
a feedback circuit that outputs a feedback signal corresponding to the drive signal, wherein
the level switching signal output circuit switches the electrical potential of the level switching signal in accordance with the feedback signal in a period of time when a voltage value of a signal waveform defined by the base drive signal changes.

9. The liquid ejecting apparatus according to claim 1, wherein
the level shift circuit includes
a gate driver that outputs a first gate signal and a second gate signal in accordance with the level switching signal,
a first transistor in which a conduction state between a drain terminal and a source terminal is controlled in accordance with the first gate signal,
a second transistor in which a conduction state between a drain terminal and a source terminal is controlled in accordance with the second gate signal, and
a bootstrap circuit to which the first amplified modulated signal and a level shift voltage signal are input, and that outputs a bootstrap voltage signal obtained by shifting the reference electrical potential of the first amplified modulated signal in accordance with the level shift voltage signal,
the bootstrap voltage signal is input to the drain terminal of the first transistor,
the first amplified modulated signal is input to the source terminal of the second transistor,
the source terminal of the first transistor and the drain terminal of the second transistor are electrically coupled at a coupling point,
the gate driver outputs the first gate signal for controlling the first transistor to be conductive between the drain terminal and the source terminal of the first transistor when the level switching signal is at the first electrical potential, and outputs the second gate signal for controlling the second transistor to be conductive between the drain terminal and the source terminal of the second transistor when the level switching signal is at the second electrical potential, and
the level shift circuit outputs a signal at the coupling point as the second amplified modulated signal.

10. The liquid ejecting apparatus according to claim 9, wherein
the bootstrap circuit includes a bootstrap capacitor having a first end electrically coupled to the drain terminal of the first transistor, and a second end electrically coupled to the coupling point, and
the level switching signal output circuit switches the electrical potential of the level switching signal to be output, in accordance with a difference in electrical potential between the first end and the second end of the bootstrap capacitor.

11. A method of controlling a liquid ejecting apparatus including
an ejection head that includes a plurality of capacitive loads that are driven when a drive signal is supplied to the plurality of capacitive loads, and that ejects liquid by driving the plurality of capacitive loads,
a capacitive load drive circuit that outputs the drive signal, and
a control circuit that controls the ejection head and the capacitive load drive circuit, the method comprising:
outputting a waveform information signal including waveform information of the drive signal, and a drive element number information signal including information indicating a number of elements that are among the plurality of capacitive loads and are to be driven by the drive signal;
outputting a modulated signal obtained by modulating a base drive signal on which the drive signal is based;
outputting a first amplified modulated signal obtained by amplifying the modulated signal;
outputting a level switching signal that changes between a first electrical potential and a second electrical potential;
outputting, as a second amplified modulated signal, a signal obtained by shifting a reference electrical potential of the first amplified modulated signal when the level switching signal is at the first electrical potential, and outputting the first amplified modulated signal as the second amplified modulated signal when the level switching signal is at the second electrical potential; and
demodulating the second amplified modulated signal and outputting the drive signal, wherein
in the outputting the level switching signal, an electrical potential of the level switching signal is switched in accordance with at least one of the waveform information signal or the drive element number information signal.

12. The method according to claim 11, wherein
the drive element number information signal is generated based on a switching control signal for switching whether to supply the drive signal to the plurality of capacitive loads.

13. The method according to claim 12, wherein
the drive element number information signal is output in each dot formation period in which a dot is formed on a medium by the liquid ejected from the ejection head.

14. The method according to claim 11, wherein
in the outputting the level switching signal,
when a voltage value of a signal waveform defined by the base drive signal increases and becomes constant, the level switching signal at the first electrical potential is output for a first period of time defined in accordance with at least one of the waveform information signal or the drive element number information signal.

15. The method according to claim 11, wherein
in the outputting the level switching signal,
when a voltage value of a signal waveform defined by the base drive signal decreases and becomes constant, the level switching signal at the second electrical potential is output for a second period of time defined in accordance with at least one of the waveform information signal or the drive element number information signal.

16. The method according to claim 11, wherein
in the outputting the level switching signal,
in a period of time when a voltage value of a signal waveform defined by the base drive signal increases, a total period of time when the level switching signal at the first electrical potential is output is longer in a case where the number of elements to be driven is p1 than in a case where the number of elements to be driven is p2 that is less than p1.

17. The method according to claim 11, wherein
in the outputting the level switching signal,
in a period of time when a voltage value of a signal waveform defined by the base drive signal decreases, a total period of time when the level switching signal at the second electrical potential is output is longer in a case where the number of elements to be driven is q1 than in a case where the number of elements to be driven is q2 that is less than q1.

18. The method according to claim 11, wherein
in the outputting the level switching signal,
in a period of time when a voltage value of a signal waveform defined by the base drive signal changes, the electrical potential of the level switching signal is switched in accordance with a feedback signal corresponding to the drive signal.

19. The method according to claim 11, wherein
the capacitive load drive circuit includes
a gate driver that outputs a first gate signal and a second gate signal in accordance with the level switching signal,
a first transistor in which a conduction state between a drain terminal and a source terminal is controlled in accordance with the first gate signal,
a second transistor in which a conduction state between a drain terminal and a source terminal is controlled in accordance with the second gate signal, and
a bootstrap circuit to which the first amplified modulated signal and a level shift voltage signal are input, and that outputs a bootstrap voltage signal obtained by shifting the reference electrical potential of the first amplified modulated signal in accordance with the level shift voltage signal,
the bootstrap voltage signal is input to the drain terminal of the first transistor,
the first amplified modulated signal is input to the source terminal of the second transistor,
the source terminal of the first transistor and the drain terminal of the second transistor are electrically coupled at a coupling point,
the gate driver outputs the first gate signal for controlling the first transistor to be conductive between the drain terminal and the source terminal of the first transistor when the level switching signal is at the first electrical potential, and outputs the second gate signal for controlling the second transistor to be conductive between the drain terminal and the source terminal of the second transistor when the level switching signal is at the second electrical potential, and
the gate driver outputs a signal at the coupling point as the second amplified modulated signal.

20. The method according to claim 19, wherein
the bootstrap circuit includes a bootstrap capacitor having a first end electrically coupled to the drain terminal of the first transistor, and a second end electrically coupled to the coupling point, and
in the outputting the level switching signal, the electrical potential of the level switching signal to be output is switched in accordance with a difference in electrical potential between the first end and the second end of the bootstrap capacitor.
